(19) United States
(12) Patent Application Publication
(10) Pub. No.: US 2026/0028499 A1
(43) Pub. Date: Jan. 29, 2026

(54) COATING COMPOSITIONS AND METHODS FOR MAKING SAME

(71) Applicants: Pavel IIMENEV, Baton Rouge, LA (US); Dave WARD, Baton Rouge, LA (US)

(72) Inventors: Pavel IIMENEV, Baton Rouge, LA (US); Dave WARD, Baton Rouge, LA (US)

(21) Appl. No.: 19/079,447

(22) Filed: Mar. 13, 2025

Related U.S. Application Data
(60) Provisional application No. 63/676,861, filed on Jul. 29, 2024.

(51) Int. Cl. C09D 125/06; C09D 5/02; C09D 125/14; C09D 125/16; C09D 133/02; C09D 133/06; C09D 133/10

(52) U.S. Cl. CPC C09D 125/06; C09D 5/022; C09D 125/14; C09D 125/16; C09D 133/02; C09D 133/064; C09D 133/10

(57) ABSTRACT

Disclosed herein are coating compositions that include styrene and/or substituted styrene polymer particles and have tunable physical properties. In a specific embodiment, a coating composition includes: one or more polymers, where the one or more polymers include: one or more substituted styrenes and one or more acrylates, where the one or more substituted styrenes is selected from meta-vinyltoluene, para-vinyltoluene, meta-methylstyrene, para-methylstyrene, para-tertiary butylstyrene, and mixtures thereof, and where the one or more acrylates is selected from 2-ethylhexyl acrylate, acrylic acid, one or more (methyl)acrylates, one or more (ethyl)acrylates, butylacrylate, and mixtures thereof; one or more carrier fluids; and one or more additives.

### CROSS-REFERENCE TO RELATED APPLICATIONS

This application claims benefit of priority under 35 U.S.C. § 119(e) of U.S. Ser. No. 63/676,861, filed Jul. 29, 2024, the entire contents of which is incorporated herein by reference in its entirety.

### BACKGROUND

### Field

Coating compositions that include substituted styrenes and have tunable physical properties are described.

### Description of the Related Art

Many commercial woods are difficult to bond. Poor adhesion of wood, especially hardwood, with adhesives and coatings is a significant challenge for the acceptance of numerous timber species by wood product manufacturers. The poor adhesion of hardwoods and some softwoods can be caused by interference of extractives and moisture, absence of durable chemical bonds between structural constituents of wood and adhesives or paints, and poor interlocking of adhesive with cell cavities. Poor interfacial adhesion at the interface between the polymer and natural fibers can be a problem due to the lack of adequate adhesion between the polymer matrix and the natural polymer fillers.

Primer compositions and surface treatments are widely used to improve the bonding of coatings and adhesives with wood or wood products. They are used to provide good adhesion to the substrate surface and provide a satisfactory bond between the surface and the coating or adhesive and provide satisfactory surface stability until application of the coating or adhesive. For example, latex type primers are commonly used but to obtain the necessary durability and attractive appearance for exterior applications, it is recommended that the latex based primer be coated with two additional layers of latex paint. The latex primer improves adhesion to the substrate and helps to ensure a uniform appearance.

Styrene (ST) is a common monomer used to prepare emulsions or latexes that are widely used in primers, coatings, and adhesives. However, some industrial applications require polymers with a broader range of physical properties than found in many styrene-based polymers to be effective. For example, some applications require monomers and polymers to have higher or more tunable boiling points, hydrophobicity, and glass transition temperatures.

Consequently, there is a need for new coating compositions that can provide the surface of wood or wood-based articles with good adhesion and can have tunable physical properties.

### SUMMARY

Provided herein are coating compositions that include substituted styrenes. In one specific embodiment, a coating composition that includes: one or more polymers, where the one or more polymers include: one or more substituted styrenes and one or more acrylates, where the one or more substituted styrenes is selected from meta-vinyltoluene, para-vinyltoluene, meta-methylstyrene, para-methylstyrene, para-tertiary butylstyrene, and mixtures thereof, and where the one or more acrylates is selected from 2-ethylhexyl acrylate, acrylic acid, one or more (methyl)acrylates, one or more (ethyl)acrylates, butylacrylate, and mixtures thereof, one or more carrier fluids; and one or more additives.

In another specific embodiment, a method for making a coating composition, the method includes: contacting a one or more surfactants, a chain transfer agent, one or more styrene monomers, one or more acrylic monomers, a first carrier fluid, and a first catalyst to produce a prepolymer, where the one or more styrene monomers is selected from styrene, meta-vinyltoluene, para-vinyltoluene, meta-methylstyrene, para-methylstyrene, para-tertiary butylstyrene, and mixtures thereof, and where the one or more acrylic monomers is selected from 2 ethylhexyl acrylate acrylic acid, one or more acrylates, one or more (methyl)acrylates, one or more (ethyl)acrylates, 2-ethylhexylacrylate, butylacrylate, and mixtures thereof; combining the prepolymer with a second carrier fluid, and a second catalyst to produce a second reaction mixture; polymerizing the prepolymer to make one or more polymers; and adding one or more additives to the one or more polymers to make the coating composition.

### DETAILED DESCRIPTION

In one or more embodiments, the coating composition can include, but is not limited to, one or more latexes, one or more carrier fluids, one or more additives, and combinations thereof. The one or more latexes can include, but are not limited to: one or more styrenes, one or more substituted styrenes, one or more substituted styrene monomers, one or more acrylates, one or more acrylic monomers, one or more catalysts, one or more cocatalysts, one or more catalyst reactivators, one or more solvents, one or more carrier fluids, one or more curing agents, one or more biocides, one or more additives, and mixtures thereof. In some embodiments, the substituted styrene polymer can include, but is not limited to: a polymer, copolymer, block copolymer, terpolymer, and mixtures thereof. In some embodiments, the substituted styrene polymer is capable of being cured to form crosslinked polymers.

The one or more substituted styrene monomers can include, but is not limited: meta-vinyltoluene, para-vinyltoluene, meta-methylstyrene, para-methylstyrene, tertiary butylstyrene, and mixtures thereof. In some embodiments, higher boiling point/lower vapor pressure monomers can beneficial in applications where a reactive diluent is used, for example, unsaturated polyesters, alkyds, UV cure, etc. In some embodiments, higher Tg than VT and ST, substitution of PMS for ST can be made with minimal reformulation to improve performance—hardness, rigidity, and thermoresistance when used in specialty coatings, sealants, and adhesives. In some embodiments, tert-butyl styrene can impart higher hardness and weathering resistance to emulsion polymers, enhancing properties of waterborne coatings and adhesives.

The substituted styrene polymer can have a content of the substituted styrene that can vary widely. For example, the substituted styrene polymer can have a substituted styrene content from a low of about 0 wt %, about 5 wt %, or about 30 wt %, to a high of about 70 wt %, about 80 wt %, or about 95 wt %. In another example, the substituted styrene polymer can have substituted styrene content of at least 45 wt %, at least 50 wt %, or at least 55 wt %. In another example, the substituted styrene polymer can have a substituted styrene content from about 5 wt % to about 95 wt %, about 25 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 20 wt % to 30 wt %, about 50 wt % to about 60 wt %, or about 70 wt % to about 80 wt %. The weight percent of the substituted styrene in the substituted styrene polymer copolymer can be based on the total weight of the substituted styrene polymer; or based on the total weight of the one or more substituted styrenes, one or more acrylates, one or more carrier fluids, and one or more additives.

The one or more acrylic monomers can include, but is not limited: methacrylic acid, acrylic acid, one or more acrylates, one or more (methyl)acrylates, one or more (ethyl)acrylates, 2-ethylhexylacrylate, butylacrylate, and mixtures thereof.

The substituted styrene polymer can have a content of the acrylate that can vary widely. For example, the substituted styrene polymer can have an acrylate content from a low of about 0 wt %, about 5 wt %, or about 30 wt %, to a high of about 70 wt %, about 80 wt %, or about 95 wt %. In another example, the substituted styrene polymer can have an acrylates content from about 5 wt % to about 95 wt %, about 25 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 20 wt % to 30 wt %, about 50 wt % to about 60 wt %, or about 70 wt % to about 80 wt %. The weight percent of the acrylate in the substituted styrene polymer can be based on the total weight of the substituted styrene polymer; or based on the total weight of the one or more substituted styrenes, one or more acrylates, one or more carrier fluids, and one or more additives.

The substituted styrene polymer can have an substituted styrene monomer:acrylic monomer ratio that varies widely. For example, the substituted styrene polymer can have an substituted styrene monomer:acrylic monomer ratio can be 10:90, 20:80, 30:70, 40:60, 50:50; 60:40, 63:37, 70:30, 80:20, and 90:10. In another example, the substituted styrene polymer can have an substituted styrene monomer:acrylic monomer ratio between 40:60 and 80:20, 30:70 and 40:60, or 30:70 and 50:50.

TABLE 1
Basic Monomer Properties

| Monomer | ST | VT | PMS | TBS |
|---|---|---|---|---|
| | 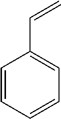 | 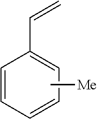 | 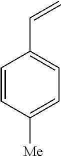 | 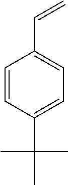 |
| CAS RN | 100-42-5 | 25013-15-4 | 622-97-9 | 1746-23-2 |
| Mol. wt. | 99.7 | 118.18 | 118.18 | 160.55 |
| b.p., ° C. | 145 | 158 | 170 | 219 |
| Homopolymer | 105 | 92 | 112 | 137 |
| Tg* | | | | |
| Solubility | Approx. | Approx. | — | Approx. |
| in | 0.03% | 0.009% | | 0.003% |
| water | [1] | [2] | | [3] |

*generated values, Deltech

Recently, in addition to the well-established niche applications like plastic scintillators, new applications emerged, making use of the unique chemistry of substituted styrenic monomers. They replace styrene in thermosets and their composites as reactive diluents (RD) for alkyd resins, vinyl esters, and unsaturated polyesters. Styrene, a traditional RD, is a toxic VOC and is listed as a potential carcinogen by NIH. [6] TBS and VT are specifically claimed as “high Tg hydrophobic monomers”, useful in preparation of aqueous dispersions of multistage opaque polymer particles for reduction of TiO2 load [7]. They find use in radiation curable coatings, ink-jet printing ink [11], heavy metal separation membranes, antimicrobial surfaces, fuel cells, desalination membranes [12, 13] for water transport, filtration and separation, and in a solid yet transparent material that can provide long-lasting antimicrobial protection on public surfaces. Other applications include syntactic foams for deep sea buoyancy applications [24], heat resistant optical film for polarizing plate [14], high volume cost-effective manufacturing at the nanoscale (semiconductors), microlithography, conformance coatings in microchip manufacturing, thin film patterning in semiconductor devices manufacturing and computer memory (spontaneous self-assembly into sub-50 nm domains) [15, 19]. Some other applications include medical devices (blood compatibility) [16], multi-block copolymers with controlled sulfonation for use in ion-exchange resins, polyelectrolytes, oil-water separation membranes [17], elastomeric graft copolymers with high utility temperature [18], plastic scintillators, where PVT provide higher light output than PST, PMMA [20], solid electrolytes for batteries [21], specialty high performance coatings—improving protective and barrier properties, thermoresistant plastics for biotech/pharma, medical applications. PMS and, especially TBS, are expected to improve crazing resistance and allow for steam sterilization under mild conditions, which makes them suitable for substantial market for medical devices and biotech/pharma consumables—drug delivery, storage. Yet another application where PMS provides improvement is a copolymer composition for a polymeric binder in an intumescent coating [22].

Glass transition temperature (T_{g}) is an important characteristic of an amorphous polymer. T_{g} of a copolymer translates into performance characteristics of the end product—hardness, film forming, mechanical strength, thermal resistance, etc. Different applications require polymers with different T_{g}. The substituted styrene polymer can have a glass transition temperature (T_{g}) that varies widely. For example, the substituted styrene polymer can have a glass transition temperature from a low of about −80° C., about −50° C., or about −40° C., to a high of about 0° C., about 50° C., or about 120′° C. In another example, the substituted styrene polymer can have a glass transition temperature from about −60° C. to about 0° C., about −55° C. to about 45° C., about −45° C. to about 35° C., 76° C. to about 107° C., or 70° C. to about 150° C. There was a significant discrepancy in T_{g} values for substituted styrenic monomers published in the literature [4, 5].

Glass transitions for homopolymers of meta- and para-methylstyrene isomers (components of VT) vary significantly: from about 75° C. to about 107° C., meta-isomer produces polymer with T_{g} lower than PST. For the pilot batches of homo VT and PMS, the Tg values were 92° C. and 102° C. correspondingly. For consistency in Tg values, the monomers were polymerized in vials and Tg was measured by DSC (reported as a midpoint of the transition).

TABLE 2
Data Summary on Glass Transition
Temperature of Homopolymers.

| | wt. % para | | | |
|---|---|---|---|---|
| monomer | isomer | [4] | [5] | Deltech, 2023* |
| ST | n.a. | | 100 | 105 |
| m-methylstyrene | 0 | 75 ** | 97 | |
| | 34 | 88 | | |
| VT | 45 | | | 92 |
| | 89.3 | 106 | | |
| PMS | 95 | | | 112 |
| | 95.5 | 110 | | |
| | 97 | 111 | | |
| | 99.7 | 113 | | |
| p-methylstyrene | 100 | | 97 | |
| TBS | 95 | | 127 | 137 |

*DSC, midpoint
** extrapolated

The substituted styrene polymer and/or polymer emulsion can have a König hardness that varies widely. For example, the substituted styrene polymer and/or polymer emulsion can have a König hardness from a low of about 15 seconds, about 30 seconds, or about 35 seconds, to a high of about 110 seconds, about 150 seconds, or about 200 seconds. In another example, the substituted styrene polymer and/or polymer emulsion can have a König hardness from about 15 seconds to about about 200 seconds, about 20 seconds to about 50 seconds, about 25 seconds to about 70 seconds, about 30 seconds to about 80 seconds, about 40 seconds to about 100 seconds, about 70 seconds to about 150 seconds, or about 90 seconds to about 170 seconds.

In some embodiments, the substituted styrene polymer particles can be produced by polymerizing one or more substituted styrene monomers, one or more acrylic monomers, and/or one or more prepolymers in a suspension and/or emulsion polymerization process. The substituted styrene monomer and the acrylate monomers can be mixed, blended, or otherwise combined with a first catalyst to produce a first reaction mixture. The first reaction mixture can be reacted to form or otherwise produce a prepolymer. The substituted styrene monomer, the acrylic monomer, and/or the prepolymer can be mixed, blended, or otherwise combined with a second catalyst and a carrier fluid to produce a second reaction mixture. The second reaction mixture can be an emulsion and/or suspension. The substituted styrene monomer, the acrylic monomer, and/or the prepolymer can be polymerized in the emulsion and/or suspension to produce the particles. The polymer particles can be further processed with one or more mechanical processes, such as grinding, milling, pulverizing, and the like, to reduce the structure into polymer particles.

As used herein, the term “carrier fluid” refers to any a suspension fluid, solvent, medium, diluent, dispersion fluid, emulsion fluid, and/or the continuous phase of the suspension and/or emulsion.

As used herein, the terms “suspension process,” “suspension polymerization process,” “dispersion process,” and “dispersion polymerization process” are used interchangeably and refer to a heterogeneous polymerization process that uses mechanical agitation to mix the reaction mixture in the carrier or “continuous phase” fluid such as a hydrocarbon and/or water, where the reaction mixture phase and the carrier or continuous phase fluid are not miscible. The reaction mixture can be suspended or dispersed in the carrier fluid or continuous phase as droplets, where the monomer components and/or prepolymer undergo polymerization to form particles of a polymer and/or curing to form cured particles of polymer.

As used herein, the terms “emulsion process” and “emulsion polymerization process” refer to both “normal” emulsions and “inverse” emulsions. Emulsions differ from suspensions in one or more aspects. One difference is that an emulsion will usually include the use of a surfactant that creates or forms the emulsions (small size droplets). When the carrier or continuous phase fluid is a hydrophilic fluid such as water and the reaction mixture phase is a hydrophobic compound(s), normal emulsions (e.g., oil-in-water) form, where droplets of monomer are emulsified with the aid of a surfactant in the carrier or continuous phase fluid. The monomers and/or prepolymer react in these small size droplets. These droplets are typically small in size as the particles are stopped from coagulating with each other because each particle is surrounded by the surfactant and the charge on the surfactant electrostatically repels other particles. Whereas suspension polymerization usually creates much larger particles than those made with emulsion polymerization. When the carrier or continuous phase fluid is a hydrophobic fluid such as oil and the reaction mixture phase is hydrophilic compounds, inverse-emulsions (e.g., water-in-oil) form.

As used herein, the terms “suspension and/or emulsion process” and “suspension and/or emulsion polymerization” are not limited to or necessarily refer to traditional polymerization. Instead, the terms “suspension and/or emulsion process” and “suspension and/or emulsion polymerization” may, but not necessarily, refer to a curing process or a combination of traditional polymerization and a curing process. As discussed and described herein, in one or more embodiments, the monomer component can be or include a prepolymer and/or a polymer in addition to or in lieu of the monomer mixture alone. The curing process refers to the further crosslinking or hardening of the polymer as compared to the polymerization of a monomer mixture. As such, if a prepolymer is present, the suspension/emulsion process can, in addition to or in lieu of polymerization, also include the curing process. As used herein, the term “curing” refers to the toughening or hardening of polymers via an increased degree of crosslinking of polymer chains. Crosslinking refers to the structural and/or morphological change that occurs in the prepolymer and/or polymer, such as by covalent chemical reaction, ionic interaction or clustering, phase transformation or inversion, and/or hydrogen bonding.

The components of the first reaction mixture, i.e., the substituted styrene monomer, the acrylic monomer, and the first catalyst can be combined with one another in any order or sequence. For example, the substituted styrene monomer can be added, then the acrylic monomer can be added, then the first catalyst can be added. In another example, the substituted styrene monomer, the acrylic monomer, and the first catalyst can be simultaneously combined with one another.

In one or more embodiments, the substituted styrene monomer, the acrylic monomer, and the first catalyst, can be in a liquid medium in the form of a solution, slurry, suspension, emulsion, or other mixture. For example, the substituted styrene monomer, the acrylic monomer and the first catalyst can be in the form of an aqueous solution, slurry, suspension, emulsion, or other mixture. Other suitable liquid mediums can include, but are not limited to, one or more alcohols or water/alcohol mixtures. Illustrative alcohols can include, but are not limited to, methanol, ethanol, propanol, isopropanol, butanol, and the like, and mixtures thereof. Other suitable liquid mediums can include, but are not limited to, acetone, tetrahydrofuran, benzene, toluene, xylene, ethylbenzene, cumene, mesitylene, or mixtures thereof. In one or more embodiments, the polymerization reactions of the substituted styrene monomer and the acrylic monomer can produce water as a liquid medium.

The concentration of the liquid medium in the first reaction mixture can range from a low of about 5 wt %, about 10 wt %, about 15 wt %, about 20 wt %, about 25 wt %, about 30 wt %, about 35 wt %, about 40 wt %, or about 45 wt % to a high of about 60 wt %, about 65 wt %, about 70 wt %, about 75 wt %, about 80 wt %, about 85 wt %, about 90 wt %, or about 95 wt %, based on the total weight of the liquid medium, the substituted styrene monomer, the acrylic monomer, and the first catalyst.

If any one or more of the components discussed and described herein include two or more different compounds, those two or more different compounds can be present in any ratio with respect to one another. For example, if the substituted styrene monomer includes a first substituted styrene monomer and a second substituted styrene monomer, the substituted styrene monomer can have a concentration of the first substituted styrene monomer be from about 1 wt % to about 99 wt % and conversely about 99 wt % to about 1 wt % of the second substituted styrene monomer, based on the total weight of the first and second substituted styrene monomer. In another example, the amount of the first substituted styrene monomer can be from a low of about 5 wt %, about 10 wt %, about 15 wt %, about 20 wt %, about 25 wt % about 30 wt %, about 35 wt %, about 40 wt %, or about 45 wt % to a high of about 60 wt %, about 65 wt %, about 70 wt %, about 75 wt %, about 80 wt %, about 85 wt %, about 90 wt %, or about 95 wt %, based on the total weight of the first and second substituted styrene monomer. When the crosslinking compound, catalyst, and/or liquid medium includes two or more different compounds, those two or more different compounds can be present in similar amounts as the first and second substituted styrene monomer.

The first catalyst can also be referred to as an initiator, a reducer, and/or an accelerator. The first catalyst can be unconsumed by the polymerization reaction. The first catalyst can be partially consumed by the polymerization reaction. The first catalyst can be consumed by the polymerization reaction. For example, consumption or at least partial consumption of the first catalyst can include the first catalyst reacting with the substituted styrene monomer, the acrylic monomer, the second catalyst (upon the addition thereof), the prepolymer, itself, or any combination thereof. The first catalyst can include one or more amines and/or one or more metal catalysts. Illustrative first catalysts can include, but are not limited to ammonia, dimethylethanolamine (DMEA), ethylenediamine (EDA), triethylamine (TEA), trimethylamine, tripropylamine, diethylethanolamine, hexamethylenetetramine (hexamine), lithium carbonate, and any mixture thereof.

The concentration of the first catalyst in the first reaction mixture can be from about 0.001 wt % to about 30.0 wt %, based on the weight of the substituted styrene monomer. For example, the concentration of the first catalyst in the first reaction mixture can be from about 0.001 wt % to about 0.01 wt %, about 0.01 wt % to about 1.0 wt %, about 0.1 wt % to about 1.0 wt %, about 2.0 wt % to about 3.0 wt %, about 3.0 wt % to about 5.0 wt %, about 5.0 wt % to about 10.0 wt %, based on the weight of the substituted styrene monomer. In another example, the concentration of the first catalyst can be from a low of about 0.05 wt %, about 0.1 wt %, about 0.5 wt %, about 1 wt %, about 1.5 wt %, about 2.0 wt %, about 2.5 wt %, about 3.0 wt %, about 3.5 wt %, about 4.0 wt %, about 4.5 wt %, or about 5.0 wt % to a high of about 7.0 wt %, about 10.0 wt %, about 13 wt %, about 15 wt %, about 17.0 wt %, about 20.0 wt %, about 23.0 wt %, about 25.0 wt %, about 27.0 wt %, or about 30.0 wt %, based on the weight of the substituted styrene monomer.

The concentration of the first catalyst in the first reaction mixture can be from about 0.001 wt % to about 30.0 wt %, based total weight of the substituted styrene monomer, the acrylic monomer, and the liquid medium. For example, the concentration of the first catalyst in the first reaction mixture can be from about 0.001 wt % to about 4.0 wt %, based on the total weight of the substituted styrene monomer, the acrylic monomer, and the liquid medium. In another example, the concentration of the first catalyst in the first reaction mixture can be from about 0.001 wt % to about 0.1 wt %, about 0.1 wt % to about 2 wt %, about 2 wt % to about 3 wt %, about 3 wt % to about 5 wt %, about 5 wt % to about 10 wt %, based on the total weight of the substituted styrene monomer, the acrylic monomer, and the liquid medium. In another example, the concentration of the first catalyst in the first reaction mixture can be from a low of about 0.05 wt %, about 0.1 wt %, about 0.5 wt %, about 1 wt %, about 1.5 wt %, about 2 wt %, about 2.5 wt %, about 3 wt %, about 3.5 wt %, about 4 wt %, about 4.5 wt %, or about 5 wt % to a high of about 7 wt %, about 10 wt %, about 13 wt %, about 15 wt %, about 17 wt %, about 20 wt %, about 23 wt %, about 25 wt %, about 27 wt %, or about 30 wt %, based on the total weight of the substituted styrene monomer, the acrylic monomer, and the liquid medium. In another example, the concentration of the first catalyst in the first reaction mixture can be from a low of about 0.05 wt %, about 0.1 wt %, about 0.5 wt %, about 1 wt %, about 1.5 wt %, about 2 wt %, about 2.5 wt %, about 3 wt %, about 3.5 wt %, about 4 wt %, about 4.5 wt %, or about 5 wt % to a high of about 7 wt %, about 10 wt %, about 13 wt %, about 15 wt %, about 17 wt %, about 20 wt %, about 23 wt %, about 25 wt %, about 27 wt %, or about 30 wt %, based on the total weight of the substituted styrene monomer, the acrylic monomer, and a carrier fluid.

The molar ratio of the substituted styrene monomer to first catalyst can range from a low of about 1 to a high of about 400. For example, the molar ratio of the substituted styrene monomer to first catalyst can range from a low of about 1, about 5, about 10, or about 15 to a high of about 45, about 50, about 60, about 80, about 100, about 125, about 150, about 175, about 200, about 225, about 250, about 275, about 300, about 325, or about 350. In another example, the molar ratio of the substituted styrene monomer to first catalyst can range from a low of about 1, about 3, about 5, about 8, about 10, about 12, or about 15 to a high of about 20, about 25, about 20, about 37, about 40, about 43, about 45, or about 49. In another example, the molar ratio of the substituted styrene monomer to first catalyst can be less than 200, less than 150, less than 125, less than 100, less than 75, less than 60, less than 50, less than 49, less than 47, less than 45, less than 43, less than 40, less than 37, or less than 35.

Prior to forming or producing the suspension and/or emulsion with the carrier fluid, the substituted styrene monomer and acrylic monomer can be at least partially polymerized with one another to produce a prepolymer. For example, the substituted styrene monomer and acrylic monomer can be prepolymerized with a first catalyst in a first reaction mixture. The prepolymerization can be performed at a reaction temperature of about 20° C., about 30° C., about 40° C., about 50° C., or about 60° C. In another example, the substituted styrene monomer and acrylic monomer can be prepolymerized with the first catalyst in the first reaction mixture at a temperature from about 40° C. to about 60° C., about 60° C. to about 80° C., or about 80° C. to about 100° C. In another example, the substituted styrene monomer and acrylic monomer can be prepolymerized at a temperature form a low of about 20° C., about 40° C., about 60° C., about 80° C., or about 90° C. to a high of about 95° C., about 100° C., about 125° C., 150° C., about 175° C., about 200° C., about 225° C., about 250° C., about 275° C., or about 300° C. In one or more embodiments, the substituted styrene monomer and acrylic monomer can be pre-polymerized under pressure and the temperature during the prepolymerization can be up to the boiling point of the reaction mixture. In one or more embodiments, the substituted styrene monomer and acrylic monomer can be pre-polymerized under pressure and the temperature during the prepolymerization can be less than the boiling point of the reaction mixture.

The reaction of first reaction mixture can be carried out under a wide range of pH values. For example, the first reaction mixture can be at a pH from a low of about 1, about 2, or about 3 to a high of about 7, about 8, about 9, about 10, about 11, or about 12. In one or more embodiments, the first reaction mixture can be at acidic conditions. For example, the pH of the first reaction mixture can be less than about 7, less than about 6.5, less than about 6, less than about 5.5, less than about 5, less than about 4.5, or less than about 4. In another example, the pH of the first reaction mixture can be from about 1 to about 6.5, about 1.5 to about 5.5, about 2 to about 5, about 1.5 to about 4.5, about 1 to about 4, about 2 to about 4, about 1 to about 3.5, or about 2 to about 4.5.

In some embodiments, the prepolymer can have a molar ratio of the one or more substituted styrene monomers to the one or more acrylic monomers from a low of about 0.1:1 to a high of about 1.5:1. For example, the prepolymer can have a molar ratio of the one or more substituted styrene monomers to the one or more acrylic monomers can be about 0.2:1 to about 1.4:1, about 0.8:1 to about 1.3:1, about 0.2:1 to about 0.9:1, about 0.3:1 to about 0.8:1, about 0.4:1 to about 0.8.1, about 0.4:1 to about 0.7.1, or about 0.4:1 to about 0.6:1. In at least one example, the prepolymer can have a molar ratio of the one or more substituted styrene monomers to the one or more acrylic monomers can be about 0.4:1, about 0.5:1, about 0.6.1, about 0.7:1, about 0.8:1, about 0.9:1, or about 1:1.

In some embodiments, the prepolymer can have a weight ratio of the one or more substituted styrene monomers to the one or more acrylic monomers from a low of about 1:100 to a high of about 100:1. For example, the prepolymer can have a molar ratio of the one or more substituted styrene monomers to the one or more acrylic monomers can be about 2:1 to about 1:14, about 8:1 to about 1:13, about 20:1 to about 90:1, about 1:30 to about 1:70, about 1:10 to about 1:50, about 4:1 to about 7:1, or about 40:1 to about 6:1. In at least one example, the prepolymer can have a molar ratio of the one or more substituted styrene monomers to the one or more acrylic monomers can be about 0.4:1, about 0.5:1, about 0.6:1, about 0.7:1, about 0.8:1, about 0.9:1, or about 1:1.

In some embodiments, the polymer can have a molar ratio of the one or more substituted styrene monomers to the one or more acrylic monomers from a low of about 0.1:1 to a high of about 1.5.1. For example, the polymer can have a molar ratio of the one or more substituted styrene monomers to the one or more acrylic monomers can be about 0.2:1 to about 1.4:1, about 0.8:1 to about 1.3:1, about 0.2:1 to about 0.9.1, about 0.3:1 to about 0.8:1, about 0.4:1 to about 0.8:1, about 0.4:1 to about 0.7:1, or about 0.4:1 to about 0.6:1. In at least one example, polymer can have a molar ratio of the one or more substituted styrene monomers to the one or more acrylic monomers can be about 0.4:1, about 0.5:1, about 0.6:1, about 0.7:1, about 0.8:1, about 0.9:1, or about 1:1.

In some embodiments, the polymer can have a weight ratio of the one or more substituted styrene monomers to the one or more acrylic monomers from a low of about 1:100 to a high of about 100:1. For example, the polymer can have a molar ratio of the one or more substituted styrene monomers to the one or more acrylic monomers can be about 2:1 to about 1:14, about 8:1 to about 1:13, about 20:1 to about 90:1, about 1:30 to about 1:70, about 1:10 to about 1:50, about 4.1 to about 7.1, or about 40.1 to about 6.1. In another example, the polymer can have the one or more substituted styrene monomers to the one or more acrylic monomers can be about 0.4.1, about 0.5.1, about 0 6:1, about 0.7.1, about 0.8:1, about 0.9.1, or about 1:1.

The prepolymer can have a weight average molecular weight (Mw) ranging from a low of about 200, about 300, or about 400 to a high of about 100.000, about 1,000,000, or about 10,000,000 In another example, the prepolymer can have a weight average molecular weight ranging from about 250 to about 450.000, about 45,000 to about 550,000, about 15,500 to about 29,500, about 39,500 to about 55,000, about 56,000 to about 75,000, or about 7,500 to about 111,500. In another example, the prepolymer can have a weight average molecular weight of about 10,000 to about 800,000, about 70,000 to about 333,000, about 100,100 to about 1,200,000, about 23,000 to about 550,000, about 4,000 to about 8,705, or about 475 to about 77,500.

At least a portion of the prepolymer or the first reaction mixture can be mixed, blended, stirred, or otherwise combined with one or more carrier fluids and/or one or more second catalysts to form the second reaction mixture. The second reaction mixture can be a suspension and/or emulsion. At least portion of the prepolymer can be added to the carrier fluid, the carrier fluid can be added to the prepolymer, or the prepolymer and the carrier fluid can be simultaneously combined with one another to form suspension or emulsion. The prepolymer can be a partially reacted, e.g., polymerized, mixture of the substituted styrene monomer and acrylic monomer, or fully reacted with one another to provide the prepolymer. If the prepolymer is a fully reacted product between the substituted styrene monomer and the acrylic monomer the suspension and/or emulsion process can be used to more fully cure or “age” the prepolymer therein or fully cure or “age” the prepolymer therein.

The individual components of the second reaction mixture, e.g., the substituted styrene monomer, the acrylic monomer, the first catalyst, the second catalyst and/or the prepolymer, can each independently be mixed, blended, contacted, located, placed, directed, added, disposed, or otherwise combined with the carrier fluid in any order or sequence to produce the suspension and/or emulsion. In other words, one or less than all of the components that make up the monomer component can be combined with the carrier fluid to form or produce an intermediate suspension and/or emulsion. For example, the substituted styrene monomer and the catalyst can be combined with the carrier fluid to form or produce an intermediate suspension and/or emulsion and the acrylic monomer can be combined with the intermediate suspension and/or emulsion to form or produce the suspension and/or emulsion of the reaction mixture and the carrier fluid. In another example, the carrier fluid can be combined with one or more components of the monomer component, e.g., the substituted styrene monomer, to produce an intermediate suspension and/or emulsion and one or more other components, e.g., the acrylic monomer, can be added to the intermediate suspension and/or emulsion to produce a second intermediate suspension and/or emulsion. To the second intermediate suspension and/or emulsion the catalyst can be added to produce final suspension and/or emulsion. In other words, the substituted styrene monomer, the crosslinking compound, the catalyst, and/or the carrier fluid can be combined with one another in any order or sequence and/or any two or more components can be simultaneously combined with one another to produce the suspension and/or emulsion.

In one or more embodiments, the substituted styrene monomer, the acrylic monomer, the first catalyst, the second catalyst and/or the prepolymers can be in a liquid medium in the form of a solution, slurry, suspension, emulsion, or other mixture. For example, the substituted styrene monomer, the acrylic monomer, the prepolymer, and/or the first and/or second catalyst can be in the form of an aqueous solution, slurry, suspension, emulsion, or other mixture. Other suitable liquid mediums can include, but are not limited to, one or more alcohols or water/alcohol mixtures. Illustrative alcohols can include, but are not limited to, methanol, ethanol, propanol, isopropanol, butanol, and the like, and mixtures thereof. Other suitable liquid mediums can include, but are not limited to, acetone, tetrahydrofuran, benzene, toluene, xylene, ethylbenzene, cumene, mesitylene, or mixtures thereof. In one or more embodiments, the polymerization reactions of the substituted styrene monomer, the acrylic monomer, and the prepolymers can produce water as a liquid medium.

The concentration of the liquid medium in the substituted styrene monomer, acrylic monomer, and/or prepolymers can range from a low of about 5 wt %, about 10 wt %, about 15 wt %, about 20 wt %, about 25 wt %, about 30 wt %, about 35 wt %, about 40 wt %, or about 45 wt % to a high of about 60 wt %, about 65 wt %, about 70 wt %, about 75 wt %, about 80 wt %, about 85 wt %, about 90 wt %, or about 95 wt %, based on the total weight of the liquid medium, the substituted styrene monomer, the acrylic monomer, and the first catalyst and/or second catalysts.

The second catalyst can also be referred to as an initiator, a reducer, and/or an accelerator. The second catalyst can be unconsumed by the polymerization reaction. The second catalyst can be partially consumed by the polymerization reaction. The second catalyst can be consumed by the polymerization reaction. For example, consumption or at least partial consumption of the second catalyst can include the second catalyst reacting with the substituted styrene monomer, the acrylic monomer, the first catalyst, the prepolymer, itself, or any combination thereof. The second catalyst can include one or more dicarboxylic acids, one or more anhydrides, one or more dihydroxybenzenes, any combination thereof, or any mixture thereof. Illustrative second catalysts can include, but are not limited to, maleic anhydride, maleic acid, phthalic anhydride, phthalic acid, resorcinol, catechol, hydroquinone, bisphenol A, bisphenol F, any combination thereof, or any mixture thereof. For example, the second catalyst can include maleic anhydride, resorcinol, or a mixture of maleic anhydride and resorcinol.

The concentration of the second catalyst in the second reaction mixture can be from about 0.001 wt % to about 30.0 wt %, based on the weight of the substituted styrene monomer. For example, the concentration of the second catalyst in the second reaction mixture can be from about 0.001 wt % to about 0.01 wt %, about 0.01 wt % to about 0.1 wt %, about 0.01 wt % to about 2.0 wt %, about 1.0 wt % to about 2.0 wt %, about 2.0 wt % to about 3.0 wt %, about 3.0 wt % to about 5.0 wt %, about 5.0 wt % to about 10.0 wt %, based on the weight of the substituted styrene monomer. In another example, the concentration of the second catalyst in the second reaction mixture can be from a low of about 0.001 wt %, about 0.03 wt %, about 0.5 wt %, about 0.7 wt %, about 1.0 wt %, about 1.3 wt %, about 1.5 wt %, about 1.7 wt %, about 2 wt %, about 2.3 wt %, bout 2.5 wt %, about 3.0 wt %, about 3.5 wt %, about 3.7 wt %, or about 4.0 wt % to a high of about 5.0 wt %, about 5.5 wt %, about 6 wt %, about 6.5 wt %, about 7.0 wt %, about 7.5 wt %, about 8.0 wt %, about 8.5 wt %, about 9 wt %, or about 9.5 wt %, based on the weight of the substituted styrene monomer.

The concentration of the second catalyst in the second reaction mixture can be from about 0.001 wt % to about 30 wt %, based on the total weight of the substituted styrene monomer, the acrylic monomer, and the liquid medium. In another example, the concentration of the second catalyst in the second reaction mixture can be from about 0.001 wt % to about 0.01 wt %, about 0.01 wt % to about 0.1 wt %, about 0.1 wt % to about 1.0 wt %, about 1 wt % to about 2 wt %, about 2 wt % to about 3 wt %, about 3 wt % to about 5 wt %, about 5 wt % to about 10 wt %, based on the total weight of the substituted styrene monomer, the acrylic monomer, and the liquid medium. In another example, the concentration of the second catalyst in the second reaction mixture can be from a low of about 0.1 wt %, about 0.3 wt %, about 0.5 wt %, about 0.7 wt %, about 1 wt %, about 1.3 wt %, about 1.5 wt %, about 1.7 wt %, about 2 wt %, about 2.3 wt %, bout 2.5 wt %, about 3 wt %, about 3.5 wt %, about 3.7 wt %, or about 4 wt % to a high of about 5 wt %, about 7 wt %, about 9 wt %, about 11 wt %, about 13 wt %, about 15 wt %, about 17 wt %, about 19 wt %, about 21 wt %, about 23 wt %, about 25 wt %, about 27 wt %, or about 29 wt %, based on the total weight of the substituted styrene monomer, the acrylic monomer, and the liquid medium. In another example, the concentration of the second catalyst in the second reaction mixture can be from a low of about 0.1 wt %, about 0.3 wt %, about 0.5 wt %, about 0.7 wt %, about 1 wt %, about 1.3 wt %, about 1.5 wt %, about 1.7 wt %, about 2 wt %, about 2.3 wt %, bout 2.5 wt %, about 3 wt %, about 3.5 wt %, about 3.7 wt %, or about 4 wt % to a high of about 5 wt %, about 7 wt %, about 9 wt %, about 11 wt %, about 13 wt %, about 15 wt %, about 17 wt %, about 19 wt %, about 21 wt %, about 23 wt %, about 25 wt %, about 27 wt %, or about 29 wt %, based on the total weight of the substituted styrene monomer, the acrylic monomer, and the carrier fluid (discussed in more detail below).

The molar ratio of the substituted styrene monomer to second catalyst can be from a low of about 1 to a high of about 400. For example, the molar ratio of the substituted styrene monomer to the second catalyst can range from a low of about 1, about 5, about 10, or about 15 to a high of about 45, about 50, about 60, about 80, about 100, about 125, about 150, about 175, about 200, about 225, about 250, about 275, about 300, about 325, or about 350. In another example, the molar ratio of the substituted styrene monomer to the second catalyst can be from a low of about 1, about 3, about 5, about 8, about 10, about 12, or about 15 to a high of about 20, about 25, about 20, about 37, about 40, about 43, about 45, or about 49. In another example, the molar ratio of the substituted styrene monomer to the second catalyst can be less than 200, less than 150, less than 125, less than 100, less than 75, less than 60, less than 50, less than 49, less than 47, less than 45, less than 43, less than 40, less than 37, or less than 35 and about 1 or more, about 4 or more, about 10 or more, or about 15 or more.

The suspension and/or emulsion can have a concentration of the substituted styrene monomer, acrylic monomer, and/or prepolymer from about 1 wt % to about 90 wt %, based on the combined weight of the substituted styrene monomer, acrylic monomer, the carrier fluid, and/or prepolymer. For example, the suspension and/or emulsion can have a concentration of the substituted styrene monomer, acrylic monomer, and/or prepolymer from a low of about 10 wt %, about 15 wt %, about 20 wt %, or about 25 wt % to a high of about 40 wt %, about 50 wt %, about 60 wt %, or about 70 wt %, based on the combined weight of the substituted styrene monomer, acrylic monomer, and the carrier fluid. In another example, substituted styrene monomer and acrylic monomer in the suspension and/or emulsion can be from about 25 wt % to about 35 wt %, about 20 wt % to about 45 wt %, about 30 wt % to about 50 wt %, about 10 wt % to about 25 wt %, or about 15 wt % to about 50 wt %, based on the combined weight of the substituted styrene monomer, acrylic monomer, and the carrier fluid.

The carrier fluid can be or include one or more hydrocarbons, water, or a combination or mixture thereof. Illustrative carrier fluids can include paraffinic oils, naphthenic oils, aromatic oils, or any combination or mixture thereof. Illustrative paraffinic hydrocarbons can include mineral oils or any thereof. Suitable mineral oils include one or more alkanes having from about 15 to about 40 carbon atoms. Illustrative naphthenic oils can be hydrocarbons based on cycloalkanes. Illustrative cycloalkanes can include, but are not limited to cyclohexane, cycloheptane, cyclooctane, cyclononane, cyclodecane, or any combination or mixture thereof. Another suitable carrier fluid can be or include one or more plant based or plant derived oils. Illustrative plant based or plant derived oils can include, but are not limited to, such as linseed (flaxseed) oil, castor oil, tung oil, soybean oil, cottonseed oil, olive oil, canola oil, corn oil, sunflower seed oil, peanut oil, coconut oil, safflower oil, palm oil, vegetable oil, or any combination or mixture thereof. Another suitable carrier fluid can be or include one or more chlorinated hydrocarbons. Illustrative chlorinated hydrocarbons can include, but are not limited to, carbon tetrachloride, chloroform, methylene chloride, or any combination or mixture thereof. Any type of water can be used as the carrier fluid or to make-up at least a portion of the carrier fluid. For example, the water can be distilled water, deionized water, or a combination or mixture thereof. In another example, the water can include tap water.

The use of a carrier fluid that contains or includes water can reduce the cost associated with the production of the polymer particles as compared to the use of hydrocarbons. The use of a carrier fluid that contains or includes water can also allow for an increased concentration of the monomer component relative to the carrier fluid as compared to a carrier fluid that contains one or more hydrocarbons and is free or substantially free of water, e.g., less than 5 wt % water. In other words, a carrier fluid that is or includes a majority of water, e.g., greater than about 50 wt % water, can allow for a more concentrated suspension and/or emulsion to be formed as compared to when the carrier fluid is or includes a majority of non-water fluid(s), e.g., greater than about 50 wt % hydrocarbons. The use of a carrier fluid that is or includes water may also at least partially remove any residual carrier fluid composed of one or more hydrocarbons.

The carrier fluid can have a boiling point of about 40° C. or more, about 50° C. or more, about 60° C. or more, about 70° C. or more, about 80° C. or more, about 90° C. or more, about 100° C. or more, about 110° C. or more, about 120° C. or more, about 130° C. or more, about 140° C. or more, or about 150° C. or more. The carrier fluid can have a flash point greater than about −25° C., greater than about −20° C., greater than about −10° C., greater than about 0° C., greater than about 10° C., greater than about 20° C., greater than about 30° C., greater than about 40° C., greater than about 50° C., or greater than about 60° C.

In one or more embodiments, the carrier fluid can be free or substantially free of cycloalkanes, e.g., cyclohexane, cycloheptane, cyclooctane, and the like. For example, the carrier fluid can contain less than about 1 wt % cyclohexane, based on the total weight of the carrier fluid. As such, it should also be noted that one other difference between the suspension and/or emulsion polymerization process and the conventional inverse emulsion polymerization process used to produce polymer particles can be that the use of cyclohexane as the carrier fluid can be avoided. Similarly, another difference between the suspension and/or emulsion polymerization process and the conventional inverse emulsion polymerization process used to produce polymer particles can be that the use of cycloalkanes as the carrier fluid can be avoided.

The suspension and/or emulsion can also be heated to accelerate the polymerization of the substituted styrene monomer and acrylic monomer and/or the prepolymer. For example, the suspension and/or emulsion can be heated to an elevated temperature ranging from a low of about 20° C., about 30° C., about 40° C., about 50° C., about 70° C., about 80° C., or about 90° C. to a high of about 95° C., about 100° C., about 100° C., about 125° C., 150° C., about 175° C., about 200° C., about 225° C., about 250° C., about 275° C., or about 300° C. For example, the temperature of the suspension and/or emulsion can be maintained, e.g., from about 80° C. to about 99° C., until the suspension and/or emulsion polymerization, i.e., the polymerization between the substituted styrene monomer and the acrylic monomer, reaches a desired degree or level of polymerization. In another example, the temperature of the suspension and/or emulsion can be maintained at a temperature of about 80° C. or more, about 83° C. or more, about 85° C. or more, about 87° C. or more, about 90° C. or more, about 93° C. or more, about 95° C. or more, about 97° C. or more, about 98° C. or more, about 99° C. or more, about 100° C. or more, about 103° C. or more, about 105° C. or more, about 107° C. or more, about 110° C. or more about 112° C. or more, or about 115° C. or more until the suspension and/or emulsion polymerization reaches a desired degree or level of polymerization and/or curing. As noted above, the suspension and/or emulsion process can be carried out under acidic and/or basic conditions. The suspension and/or emulsion polymerization can be conducted until the polymer particles maintain their integrity so that they do not or substantially do not “stick” or “glue” together with one another. The polymerization can be reduced or stopped by decreasing the temperature of the suspension and/or emulsion and/or polymer particles. The cooled suspension and/or emulsion and/or polymer particles can be stored for further processing.

The suspension/emulsion polymerization in the second reaction mixture can be carried out under a wide range of pH values. For example, the suspension/emulsion process can be carried out at a pH from a low of about 1, about 2, or about 3 to a high of about 7, about 8, about 9, about 10, about 11, or about 12. In one or more embodiments, the suspension/emulsion process can be carried out under acidic conditions. For example, the pH of the reaction mixture or at least the monomer component can be less than about 7, less than about 6.5, less than about 6, less than about 5.5, less than about 5, less than about 4.5, or less than about 4. In another example, the pH of the second reaction mixture can be from about 1 to about 6.5, about 1.5 to about 5.5, about 2 to about 5, about 1.5 to about 4.5, about 1 to about 4, about 2 to about 4, about 1 to about 3.5, or about 2 to about 4.5.

The suspension and/or emulsion can be agitated to improve and/or maintain a homogeneous or substantially uniform distribution of the reaction mixture within or in the carrier fluid (suspension and inverse emulsion) or a uniform or substantially uniform distribution of the carrier fluid within or in the reaction mixture (suspension and normal emulsion). The components of the suspension and/or emulsion can be combined within one or more mixers. The mixer can be or include any device, system, or combination of device(s) and/or system(s) capable of batch, intermittent, and/or continuous mixing, blending, contacting, or the otherwise combining of two or more components, e.g., the substituted styrene monomer and the crosslinking compound or the suspension and/or emulsion that includes the monomer component and the carrier fluid. Illustrative mixers can include, but are not limited to, mechanical mixer agitation, ejectors, static mixers, mechanical/power mixers, shear mixers, sonic mixers, vibration mixing, e.g., movement of the mixer itself, or any combination thereof. The mixer can include one or more heating jackets, heating coils, internal heating elements, cooling jackets, cooling coils, internal cooling elements, or the like, to regulate the temperature therein. The mixer can be an open vessel or a closed vessel. The components of the suspension and/or emulsion can be combined within the mixer under a vacuum, at atmospheric pressure, or at pressures greater than atmospheric pressure. The components of the suspension and/or emulsion can be combined within the mixer and heated to a temperature from about 1° C. to about 300° C. The mixer can be capable of producing a homogeneous suspension and/or emulsion. In other words, the mixer can produce a suspension and/or emulsion in which the distribution of the monomer component is substantially the same throughout the carrier fluid. It should be noted that an emulsion does not necessarily require any agitation in order to form and/or maintain the emulsion, but such agitation can be used to accelerate and/or improve the uniform distribution of the components within the emulsion. As such, if an emulsion alone is formed the emulsion does not necessarily require external energy such as mechanical and/or acoustic energy in order to form and/or maintain the emulsion.

The particular method or combination of methods used to agitate the suspension and/or emulsion can be used, at least in part, as one variable that can be controlled or adjusted to influence the size and/or morphology of the polymer particles in. For example, if a stirring paddle or blade agitates the suspension and/or emulsion by rotation within the suspension and/or emulsion, the speed at which the stirring paddle or blade rotates can influence the size of the polymer particles. The particular shape or configuration of the stirring paddle or blade can also influence the size of the polymer particles.

Once the suspension and/or emulsion forms the substituted styrene monomer and the acrylic monomer and/or the prepolymer can be polymerized to produce the polymer particles. As discussed and described above, the suspension and/or emulsion process can also include curing in addition to or in lieu of traditional polymerization. The substituted styrene monomer, the acrylic monomer, and/or prepolymer can form small droplets or micelles in suspension and/or emulsion. The substituted styrene monomer, acrylic monomer, and/or the prepolymer contained within the droplets or micelles can undergo polymerization and/or curing to produce the polymer particles. The liquid that can at least partially fill any pores or voids in the polymer gel particles can be present in the reaction mixture and/or formed during polymerization of the monomer component.

The substituted styrene monomer, the acrylic monomer, and/or the prepolymer can undergo suspension and/or emulsion polymerization within the mixer. The substituted styrene monomer and acrylic monomer can be removed from the mixer and introduced into another vessel or container “reactor” in which the suspension and/or emulsion can undergo suspension and/or emulsion polymerization. Illustrative mixers/reactors can include batch, intermittent, and/or continuous type mixers or reactors. A continuous mixer or reactor, for example, can be a “loop” reactor. The suspension and/or emulsion can be formed within other systems, devices, and/or combinations thereof in addition to the one or more mixers discussed and described above. For example, suitable suspension and/or emulsion polymerizations processes can also be carried out under gas phase conditions. For example, the substituted styrene monomer and acrylic monomer, the carrier fluid, and/or the second catalyst can be in the gaseous phase. In another example, the substituted styrene monomer and acrylic monomer, and the carrier fluid can be in the gaseous phase and the catalyst can be in the solid and/or liquid phase. Accordingly, in one or more embodiments, the reaction mixture or at least one or more components of the reaction mixture can be introduced to the reactor in gas phase. In one or more embodiments, the reaction mixture or at least one or more of the components thereof can be in a liquid phase. In one or more embodiments, the reaction mixture or at least one or more monomer thereof can be in a solid phase.

Other suitable suspension and/or emulsion processes can be carried out in a continuous process and/or a batch process. Illustrative processes can include, but are not limited to, continuous stirred tank reactor (CSTR), loop reactor, and/or plug flow reactors. The suspension and/or emulsion process can be carried out in one reactor or more than one reactor. When two or more reactors are used the two or more reactor same be the same or different. When two or more reactors are used the two or more reactors can be operated in series and/or parallel. These reactors may have or may not have internal cooling or heating.

In one or more embodiments, if the polymer particles are produced within the loop reactor (or any other reactor), polymer particles can be removed during, as, and/or within a relatively short time period after being produced, but prior to full cure thereof. For example, the polymer particles can be formed in a few minutes and/or after several minutes or even hours, where the polymer particles have sufficient integrity so that they do not or substantially do not “stick” or “glue” together with one another, but are not fully cured. The separated polymer particles can be introduced to a second vessel, container, or other system, device, and/or combination thereof, where the polymer particles can be further cured. The formation of the polymer particles within the loop reactor can be carried out in a first carrier fluid and when the polymer particles are removed from the reactor they can be kept in the first carrier fluid and/or separated from the first carrier fluid and combined with a second carrier fluid. For example, the carrier fluid in the loop reactor (first carrier fluid) can be or include one or more hydrocarbons and the carrier fluid in the second container (second carrier fluid) can be water. The separated first carrier fluid and/or at least a portion of any non-polymerized monomer can be recycled back to the reactor. Accordingly, the formation of the polymer particles can be carried out in a single vessel or reactor or a plurality of reactors or vessels. Additionally, the formation of the polymer particles can include the use or combination of different process conditions, e.g., temperature and/or pressure, polymer particle concentration in the carrier fluid (loop reactor as compared to the second vessel), and the like.

The suspension/emulsion process when utilizing liquid components generally can be carried out at a pressure from about 101 kPa to about 5,500 kPa or even greater. The suspension/emulsion process can also be carried out at a temperature from a low of about 0° C., about 20° C., about 40° C., or about 50° C. to a high of about 70° C., about 80° C., about 90° C., about 100° C., about 120° C., or about 150° C. Increasing the temperature can reduce the time required to polymerize and/or cure the monomer component to a desired amount. In the suspension/emulsion process particulate polymer can be formed in the carrier fluid.

Depending, at least in part, on the temperature at which the suspension and/or emulsion polymerization is carried out, the substituted styrene monomer, acrylic monomer, and/or prepolymer can polymerize and/or cure in a time from about 30 seconds to several hours. For example, the monomer mixture can be polymerized and/or cured in a time from a low of about 1 minute, about 2 minutes, about 3 minutes, about 4 minutes, about 5 minutes, about 10 minutes, about 15 minutes, or about 20 minutes to a high of about 40 minutes, about 1 hour, about 1.5 hours, about 2 hours, about 3 hours, about 4 hours, about 5 hours, about 10 hours, about 15 hours, about 20 hours, or about 24 hours.

The particular mixer and/or reactor design or configuration can also be used, at least in part, as one variable that can be controlled or adjusted to influence the size and/or morphology of the polymer particles. For example, a reactor within which the suspension and/or emulsion polymerization be carried out in can be or include “rifled” piping or conduits that can be adapted or configured to increase, decrease, and/or maintain a velocity of the suspension and/or emulsion flowing through and across a cross-section of the piping or conduit. The mixer and/or reactor can include zig-zag piping or conduits adapted or configured to increase, decrease, and/or maintain a velocity of the suspension and/or emulsion across and/or through a cross-section of the piping or conduit.

The temperature of the suspension and/or emulsion during the suspension and/or emulsion polymerization can be controlled, adjusted, or otherwise maintained using any one or more processes. For example, heating and/or cooling coils, exchangers, elements and the like can be used to control the temperature of the suspension and/or emulsion. In another example, steam, e.g., superheated steam, or other heated fluids can be injected into, directed toward, or otherwise used to heat the suspension and/or emulsion. In another example, an ultrasonic process heat can be directed toward the suspension and/or emulsion to polymerize the monomer component therein. In still another example, the suspension and/or emulsion can be subjected to a melt spinning process to produce the polymer particles. In still another example, the suspension and/or emulsion can be subjected to an extrusion process. e.g., an extrusion process similar to fiber production, to produce the polymer particles.

Any two or more components of the suspension and/or emulsion, i.e., the carrier fluid, the catalyst, the first monomer component, second monomer component, and/or the prepolymer can be directed or otherwise introduced to the mixer via a stream or pour addition. Any two or more components of the suspension and/or emulsion can be combined with one another via a spray or mist. Any two or more components of the suspension and/or emulsion can be combined with one another via a peristaltic pump. Any two or more components of the suspension and/or emulsion can be combined with one another via subsurface addition. For example, the carrier fluid can be added to the mixer and the monomer component can be directed, added, combined, or otherwise introduced to the carrier fluid in the mixture through one or more ports, nozzles, distribution grids, or the like disposed below a surface of the carrier fluid, above the surface of the carrier fluid, or a combination thereof.

The suspension and/or emulsion polymerization of the monomer component can be carried out in the presence of one or more filler materials. In other words, the suspension and/or emulsion can include one or more filler materials. The filler material can be combined with the substituted styrene monomer, the acrylic monomer, the prepolymer, the carrier fluid, or any combination or mixture thereof. The filler material can be or include solid particles, hollow particles, porous particles, or any combination thereof illustrative filler materials can include, but are not limited to, naturally occurring organic filler material such as pecan shells, inorganic oxides, inorganic carbides, inorganic nitrides, inorganic hydroxides, inorganic oxides having hydroxide coatings, inorganic carbonitrides, inorganic oxynitrides, inorganic borides, inorganic borocarbides, or any combination or mixture thereof.

In one or more embodiments, one or more surfactants can be added to the suspension and/or emulsion of the second reaction mixture if so desired. The amount of the surfactant can be from a low of about 0.3 wt %, about 0.5 wt %, about 0.7 wt %, about 1 wt %, or about 1.5 wt % to a high of about 2 wt %, about 3 wt %, about 5 wt %, about 10 wt %, or about 15 wt %, for example.

It should be noted that suspension and/or emulsion polymerization process used to produce the polymer particles can be conducted or carried out without the use of or in the substantial absence of any surfactant. Illustrative surfactants that can be absent from the suspension and/or emulsion or dispersion polymerization process include, but are not limited to, Span 80, Triton X-100, Lecithin P123, CTAB, and the like. The carrier fluid can be free or substantially free from any surfactant. The suspension and/or emulsion that includes the reaction mixture can also be free or substantially free from any surfactant. As used herein, the term “substantially free of any surfactant,” when used with reference to the carrier fluid, refers to a carrier fluid that contains surfactant in an amount less than about 1 wt %, less than about 0.5 wt %, less than about 0.3 wt %, less than about 0.2 wt %, less than about 0.1 wt %, less than about 0.7 wt %, less than about 0.05 wt %, less than about 0.3 wt %, less than about 0.01 wt %, less than about 0.007 wt %, less than about 0.005 wt %, less than about 0.003 wt %, less than about 0.001 wt %, less than about 0.0007 wt %, or less than about 0.0005 wt %, based on the total weight of the carrier fluid. As used herein, the term “substantially free of any surfactant,” when used with reference to the suspension and/or an emulsion, refers to a suspension and/or emulsion that contains surfactant in an amount less than about 1 wt %, less than about 0.5 wt %, less than about 0.3 wt %, less than about 0.2 wt %, less than about 0.1 wt %, less than about 0.7 wt %, less than about 0.05 wt %, less than about 0.3 wt %, less than about 0.01 wt %, less than about 0.007 wt %, less than about 0.005 wt %, less than about 0.003 wt %, less than about 0.001 wt %, less than about 0.0007 wt %, or less than about 0.0005 wt %, based on the total weight of the suspension and/or emulsion.

It should also be noted that the substituted styrene monomer, the acrylic monomer, and/or the prepolymer, or a combination or mixture thereof can further include one or more other additives. Illustrative additives can include, but are not limited to, sulfur, carbon black, antioxidants, zinc oxide, accelerators, cellulose, filler, rheology modifiers, thickeners, wetting agents, colorants, lubricants, leveling agents, UV stabilizers, plasticizers, silica, processing oils, softening oils, bloating agents, or any combination thereof.

As an alternative to the suspension and/or emulsion polymerization methods discussed and described herein one or more alternative polymerizations processes can be used to produce the polymer particles and/or in a non-gel form. For example, one alternative processes, can include, but is not limited to, gas phase polymerization in which the monomer component is initially in the gaseous phase and the polymer particles form within the fluidized or gaseous medium.

In one or more embodiments, the molar ratio of the one or more substituted styrene monomers to the one or more acrylic monomers of the polymer particles can be from a low of about 0.1:1 to a high of about 1.5:1. For example, the molar ratio of the one or more substituted styrene monomers to the one or more acrylic monomers can be about 0.2:1 to about 1.4:1, about 0.8:1 to about 1.3:1, about 0.2:1 to about 0.9:1, about 0.3:1 to about 0.8:1, about 0.4:1 to about 0.8.1, about 0.4.1 to about 0.7:1, or about 0.4:1 to about 0.6:1. In at least one example, the molar ratio of the one or more substituted styrene monomer to the one or more acrylic monomer can be about 0.4:1, about 0.5:1, about 0.6:1, about 0.7:1, about 0.8:1, about 0.9:1, or about 1:1.

The polymer particles can have an average cross-sectional length of about 0.1 nm or more, about 0.5 μm or more, about 0.1 mm or more, about 1.5 mm or more, about 2 mm or more, about 2.5 mm or more, about 3 mm or more, about 3.5 mm or more, about 4 mm or more, about 4.5 mm or more, about 5 mm or more, about 5.5 mm or more, or about 6 mm or more. The polymer particles can have a particle size distribution, i.e., the average cross-sectional length for any two polymer particles can vary. For example, about 10%, about 20%, about 30%, about 40%, about 50%, about 60%, about 70%, about 80%, about 90%, about 95%, or about 100% of the polymer particles can have an average cross-sectional length greater than or equal to 1 μm. In another example, about 10%, about 20%, about 30%, about 40%, about 50%, about 60%, about 70%, about 80%, about 90%, about 95%, or about 100% of the polymer particles can have an average cross-sectional length greater than or equal to 1.1 μm. In another example, about 10%, about 20%, about 30%, about 40%, about 50%, about 60%, about 70%, about 80%, about 90%, about 95%, or about 100% of the polymer particles can have an average cross-sectional length greater than or equal to 1.2 mm. In another example, about 10%, about 20%, about 30%, about 40%, about 50%, about 60%, about 70%, about 80%, about 90%, about 95%, or about 100% of the polymer particles can have an average cross-sectional length greater than or equal to 1.3 mm. In another example, about 10%, about 20%, about 30%, about 40%, about 50%, about 60%, about 70%, about 80%, about 90%, about 95%, or about 100% of the polymer particles can have an average cross-sectional length greater than or equal to 1.5 mm. In another example, about 10%, about 20%, about 30%, about 40%, about 50%, about 60%, about 70%, about 80%, about 90%, about 95%, or about 100% of the polymer particles can have an average cross-sectional length greater than or equal to 1.7 mm. In another example, about 10%, about 20%, about 30%, about 40%, about 50%, about 60%, about 70%, about 80%, about 90%, about 95%, or about 100% of the polymer particles can have an average cross-sectional length greater than or equal to 2 μm. In still another example, about 10%, about 20%, about 30%, about 40%, about 50%, about 60%, about 70%, about 80%, about 90%, about 95%, or about 100% of the polymer particles can have an average cross-sectional length greater than or equal to about 1 mm, about 1.2 mm, about 1.4 mm, about 1.6 mm, about 1.8 mm, about 2.1 mm, about 2.3 mm, or about 2.5 mm. In yet another example, about 10%, about 20%, about 30%, about 40%, about 50%, about 60%, about 70%, about 80%, about 90%, about 95%, or about 100% of the polymer particles have an average cross-sectional length greater than or equal to about 1 mm, about 1.5 mm, about 2 mm, about 2.5 mm, about 3 mm, about 3.5 mm, about 4 mm, about 4.5 mm, about 5 mm, or about 5.5 mm. In still another example, the polymer particles can have an average cross-sectional length from about 1.0 nm to about 5.0 mm, about 1.0 nm to about 5.0 μm, about 50.0 nm to about 50.0 μm, about 10.0 μm to about 50.0 μm, about 10.0 μm to about 500.0 μm, or about 10.0 μm to about 1.0 mm.

The polymer particles can have an average cross-sectional length of about 0.1 nm or more, about 0.5 mm or more, about 1 mm or more, about 1.5 mm or more, about 2 mm or more, about 2.5 mm or more, about 3 mm or more, about 3.5 mm or more, about 4 mm or more, about 4.5 mm or more, about 5 mm or more, about 5.5 mm or more, or about 6 mm or more.

The polymer particles can have a surface area from a low of about 50 m²/g, about 100 m²/g, about 200 m²/g, about 400 m²/g, or about 500 m²/g to a high of about 800 m²/g, about 1,100 m²/g, about 1,400 m²/g, about 1,700 m²/g, or about 2,000 m²/g. For example, the surface area of the polymer particles can be from about 75 m²/g to about 700 m²/g, about 350 m²/g to about 1,000 m²/g, about 850 m²/g to about 1,750 m²/g, or about 600 m²/g to about 1,300 m²/g.

The polymer particles can have a pore size from a low of about 0.2 nm, about 0.5 nm, about 1 nm, about 5 nm, or about 10 nm to a high of about 100 nm, about 200 nm, about 300 nm, about 400 nm, or about 500 nm. For example, the pore size of the polymer particles can be from about 3 nm to about 75 nm, about 15 nm to about 150 nm, about 40 nm to about 450 nm, or about 20 nm to about 300 nm.

The pore size of the polymer particles can also be referred to as being microporous (less than or equal to 2 nm), mesoporous (from 2 nm to about 50 nm), or macroporous (greater than 50 nm). The polymer particles can have only a microporous pore size distribution, only a mesoporous pore size distribution, or only a macroporous pore size distribution. In another example, the polymer particles can have a combination of microporous pore size, mesoporous pore size, and/or macroporous pore size distribution.

The polymer particles can have a monomodal pore size distribution, a bimodal pore size distribution, or a multi-modal pore size distribution. In another example, the polymer particles can have only a monomodal pore size distribution, a bimodal pore size distribution, or a multi-modal pore size distribution.

The polymer particles can have a pore volume from a low of about 0.05 cm³/g, about 0.1 cm³/g, about 0.5 cm³/g, about 1 cm³/g, or about 1.5 cm³/g to a high of about 2 cm³/g, about 2.5 cm³/g, about 3 cm³/g, about 3.5 cm³/g, or about 4 cm³/g. For example, the surface area of the polymer particles can be from about 0.05 cm³/g to about 1 cm³/g, about 0.7 cm³/g to about 3.5 cm³/g, about 0.5 cm³/g to about 3 cm³/g, or about 2.5 cm³/g to about 4 cm³/g.

In one or more embodiments, the liquid and/or carrier fluid contained in and/or on the polymer particles can be replaced with a more volatile solvent via solvent exchange. For example, the polymer particles can be contacted with a hydrocarbon solvent, e.g., acetone, which can remove at least a portion of the liquid medium and/or the carrier fluid and with the hydrocarbon solvent. The hydrocarbon solvent can then be more readily removed from the polymer particles to provide substantially dry polymer particles via supercritical extraction, air drying, freeze drying, and the like. However, the polymer particles that contain the liquid and/or carrier fluid can also be dried via supercritical, air, or freeze drying.

The separated carrier fluid can be reused. For example, the separated carrier fluid can be recycled to the same or other mixer, reactor, or other vessel and to provide at least a portion of the carrier fluid therein. The separated carrier fluid can be subjected to a cleaning process, e.g., filtration, heating, screening, centrifugation, or the like, to remove at least a portion of any contaminants therein prior to reuse.

The polymer particles after drying, after pyrolyzing, and/or after activation can have an average cross-sectional length of about 0.1 mm or more, about 0.5 mm or more, about 1 mm or more, about 1.5 mm or more, about 2 mm or more, about 2.5 mm or more, about 3 mm or more, about 3.5 mm or more, about 4 mm or more, about 4.5 mm or more, about 5 mm or more, about 5.5 mm or more, or about 6 mm or more. The polymer particles after drying, after pyrolyzing, and/or after activation can have a particle size distribution, i.e., the average cross-sectional length for any two polymer particles form can vary. For example, about 10%, about 20%, about 30%, about 40%, about 50%, about 60%, about 70%, about 80%, about 90%, about 95%, or about 100% of the polymer particles after drying, after pyrolyzing, and/or after activation can have an average cross-sectional length greater than or equal to 1 mm. In another example, about 10%, about 20%, about 30%, about 40%, about 50%, about 60%, about 70%, about 80%, about 90%, about 95%, or about 100% of the polymer particles after drying, after pyrolyzing, and/or after activation can have an average cross-sectional length greater than or equal to 1.1 mm. In another example, about 10%, about 20%, about 30%, about 40%, about 50%, about 60%, about 70%, about 80%, about 90%, about 95%, or about 100% of the polymer particles after drying, after pyrolyzing, and/or after activation can have an average cross-sectional length greater than or equal to 1.2. In another example, about 10%, about 20%, about 30%, about 40%, about 50%, about 60%, about 70%, about 80%, about 90%, about 95%, or about 100% of the polymer particles after drying, after pyrolyzing, and/or after activation can have an average cross-sectional length greater than or equal to 1.3 mm. In another example, about 10%, about 20%, about 30%, about 40%, about 50%, about 60%, about 70%, about 80%, about 90%, about 95%, or about 100% of the polymer particles after drying, after pyrolyzing, and/or after activation can have an average cross-sectional length greater than or equal to 1.5 mm. In another example, about 10%, about 20%, about 30%, about 40%, about 50%, about 60%, about 70%, about 80%, about 90%, about 95%, or about 100% of the polymer particles after drying, after pyrolyzing, and/or after activation can have an average cross-sectional length greater than or equal to 1.7. In another example, about 10%, about 20%, about 30%, about 40%, about 50%, about 60%, about 70%, about 80%, about 90%, about 95%, or about 100% of the polymer particles after drying, after pyrolyzing, and/or after activation can have an average cross-sectional length greater than or equal to 2 mm. In still another example, about 10%, about 20%, about 30%, about 40%, about 50%, about 60%, about 70%, about 80%, about 90%, about 95%, or about 100% of the polymer particles after drying, after pyrolyzing, and/or after activation can have an average cross-sectional length greater than or equal to about 1 mm, about 1.2 mm, about 1.4 mm, about 1.6 mm, about 1.8 mm, about 2.1 mm, about 2.3 mm, or about 2.5 mm. In yet another example, about 10%, about 20%, about 30%, about 40%, about 50%, about 60%, about 70%, about 80%, about 90%, about 95%, or about 100% of the polymer particles after drying, after pyrolyzing, and/or after activation can have an average cross-sectional length greater than or equal to about 1 mm, about 1.5 mm, about 2 mm, about 2.5 mm, about 3 mm, about 3.5 mm, about 4 mm, about 4.5 mm, about 5 mm, or about 5.5 mm.

The polymer particles after drying, after pyrolyzing, and/or after activation can have a surface area from a low of about 100 m²/g, about 400 m²/g, about 800 m²/g, about 1,000 m²/g, or about 1,200 m²/g to a high of about 2,000 m²/g, about 2,500 m²/g, about 3,000 m²/g, about 3,500 m²/g, or about 4,000 m²/g. For example, the polymer particles after drying, after pyrolyzing, and/or after activation form can be from about 100 m²/g to about 500 m²/g, about 300 m²/g to about 1,400 m²/g, about 700 m²/g to about 2,800 m²/g, or about 1,600 m²/g to about 3,800 m²/g.

The polymer particles after drying, after pyrolyzing, and/or after activation can have a pore size from a low of about 0.2 nm, about 0.5 nm, about 1 nm, about 5 nm, or about 10 nm to a high of about 100 nm, about 200 nm, about 300 nm, about 400 nm, or about 500 nm. For example, the polymer particles after drying, after pyrolyzing, and/or after activation can be from about 3 nm to about 75 nm, about 15 nm to about 150 nm, about 40 nm to about 450 nm, or about 20 nm to about 300 nm.

The pore size of the polymer particles after drying, after pyrolyzing, and/or after activation can also be referred to as being microporous (less than or equal to 2 nm), mesoporous (from 2 nm to about 50 nm), or macroporous (greater than 50 nm). The polymer particles after drying, after pyrolyzing, and/or after activation can have only a microporous pore size distribution, only a mesoporous pore size distribution, or only a macroporous pore size distribution. In another example, the polymer particles after drying, after pyrolyzing, and/or after activation can have a combination of microporous pore size, mesoporous pore size, and/or macroporous pore size distribution.

The polymer particles after drying, after pyrolyzing, and/or after activation can have a monomodal pore size distribution, a bimodal pore size distribution, or a multi-modal pore size distribution. In another example, the polymer particles after drying, after pyrolyzing, and/or after activation can have only a monomodal pore size distribution, a bimodal pore size distribution, or a multi-modal pore size distribution.

The polymer particles after drying, after pyrolyzing, and/or after activation can have a pore volume from a low of about 0.05 cm³/g, about 0.1 cm³/g, about 0.5 cm³/g, about 1 cm³/g, or about 1.5 cm³/g to a high of about 2 cm³/g, about 2.5 cm³/g, about 3 cm³/g, about 3.5 cm³/g, or about 4 cm³/g. For example, the pore volume of the polymer particles after drying, after pyrolyzing, and/or after activation can be from about 0.05 cm³/g to about 1 cm³/g, about 0.7 cm³/g to about 3.5 cm³/g, about 0.5 cm³/g to about 3 cm³/g, or about 2.5 cm³/g to about 4 cm³/g.

Depending, at least in part, on the end use of the polymer particles, the polymer particles may be used in a gel form, after drying, after pyrolyzing, after activation, or a combination of particles in the gel form, dried, pyrolyzed, and/or activated can be used in an application Illustrative applications that can use the polymer particles in gel form, dried, pyrolyzed, and/or activated can include, but are not limited to, insulation, energy, e.g., in capacitors, batteries, and fuel cells, medicine, e.g., drug delivery, transportation, e.g., hydrogen or other fuel storage, sensors, sports, catalysts, hazardous wastewater treatment, catalyst supports, sorbents, dielectrics, impedance matcher, detectors, filtrations, ion exchange, high-energy physics applications, waste management, such as adsorption of waste fluids and/or waste gases, and the like.

The substituted styrene polymer can have a weight-average molecular weight (M_{w}) that varies widely. For example, the substituted styrene polymer can have a weight-average molecular weight from a low of about 10,000 g/mol, about 35,000 g/mol, or about 40,000 g/mol, to a high of about 800,000 g/mol, about 900,000 g/mol, or about 1,200,000 g/mol. In another example, the substituted styrene polymer can have a weight-average molecular weight that is less than 80,000 g/mol, less than 60,000 g/mol, or less than 50,000 g/mol. In another example, the substituted styrene polymer can have a weight-average molecular weight from about 8,000 g/mol to about 250,000 g/mol, about 30,000 g/mol to about 1,200,000 g/mol, about 20,000 g/mol to about 80,000 g/mol, about 40,000 g/mol to about 80,000 g/mol, about 100,000 g/mol to about 750,000 g/mol, about 480,000 g/mol to about 1,100,000 g/mol, about 500,000 g/mol to about 1,000,000 g/mol. The molecular weight of the substituted styrene polymer can be measured by gel permeation chromatography with tri-detectors.

The substituted styrene polymer can have a number-average molecular weight (M) that varies widely. For example, the substituted styrene polymer can have a number-average molecular weight from a low of about 1,100 g/mol, about 35,000 g/mol, or about 40,000 g/mol, to a high of about 800,000 g/mol, about 900,000 g/mol, or about 1,200,000 g/mol. In another example, the substituted styrene polymer can have a number-average molecular weight that is less than 80,000 g/mol, less than 60,000 g/mol, or less than 50,000 g/mol. In another example, the substituted styrene polymer can have a number-average molecular weight from about 1,100 g/mol to about 250,000 g/mol, about 30,000 g/mol to about 1,200,000 g/mol, about 20,000 g/mol to about 80,000 g/mol, about 40,000 g/mol to about 80,000 g/mol, about 100,000 g/mol to about 750,000 g/mol, about 480,000 g/mol to about 1,100,000 g/mol, about 500,000 g/mol to about 1,000,000 g/mol.

The substituted styrene polymer can have a higher-average molecular weight (M_{z}) that varies widely. For example, the substituted styrene polymer can have a higher-average molecular weight from a low of about 10,000 g/mol, about 35,000 g/mol, or about 40,000 g/mol, to a high of about 800,000 g/mol, about 900,000 g/mol, or about 1,200,000 g/mol. In another example, the substituted styrene polymer can have a number-average molecular weight that is less than 80,000 g/mol, less than 60,000 g/mol, or less than 50,000 g/mol. In another example, the substituted styrene polymer can have a higher-average molecular weight from about 8,000 g/mol to about 250,000 g/mol, about 30,000 g/mol to about 1,200,000 g/mol, about 20,000 g/mol to about 80,000 g/mol, about 40,000 g/mol to about 80,000 g/mol, about 100,000 g/mol to about 750,000 g/mol, about 480,000 g/mol to about 1,100,000 g/mol, about 500,000 g/mol to about 1,000,000 g/mol.

The substituted styrene polymer can have a molecular weight of the highest peak (Mₚ) that varies widely. For example, the substituted styrene polymer can have a molecular weight of the highest peak from a low of about 10,000 g/mol, about 35,000 g/mol, or about 40,000 g/mol, to a high of about 800,000 g/mol, about 900,000 g/mol, or about 1,200,000 g/mol. In another example, the substituted styrene polymer can have a molecular weight of the highest peak that is less than 80,000 g/mol, less than 60,000 g/mol, or less than 50,000 g/mol. In another example, the substituted styrene polymer can have a molecular weight of the highest peak from about 8,000 g/mol to about 250,000 g/mol, about 30,000 g/mol to about 1,200,000 g/mol, about 20,000 g/mol to about 80,000 g/mol, about 40,000 g/mol to about 80,000 g/mol, about 100,000 g/mol to about 750,000 g/mol, about 480,000 g/mol to about 1,100,000 g/mol, about 500,000 g/mol to about 1,000,000 g/mol.

The substituted styrene polymer can have a polydispersity index (PDI) and/or molecular weight distribution (M_{w}/Mₙ) from a low of about 2.1, about 4.0, or about 5.0, to a high of about 6.0, about 7.0, or about 28. For example, the substituted styrene polymer can have a polydispersity index and/or molecular weight distribution from about 2.1 to about 8.6, about 3.0 to about 9.0, about 2.9 to about 7.8, about 5.0 to about 6.0, about 5.9 to about 6.2, or about 4.0 to about 7.0, about 12.3 to about 22.5, or about 2.3 to about 24.5.

The one or more solvents for the first reaction mixture, second reaction mixture, and catalyst mixture can include, but is not limited to: aliphatic hydrocarbons, such as hexanes; aromatic hydrocarbons, such as toluene and benzene; water; deionized water; methanol; ethanol; propanol; isopropanol; acetone; acetonitrile; chloroform; diethyl ether; methylene chloride; dimethyl formamide; ethylene glycol; propylene glycol; triethylamine; tetrahydrofuran; and mixtures thereof. In some embodiments, the solvent can provide a carrier for the ethylene, propylene, vinyl norbornene, catalyst, cocatalyst, and/or catalyst reactivator with a flow rate to a reactor.

The one or more substituted styrenes can include, but is not limited to: a substituted styrene monomer, substituted styrene polymer, and mixtures thereof. The substituted styrene can be provided in various forms. For example, the substituted styrene can be provided as a solution of the ethylene and a solvent.

The one or more acrylates can include, but is not limited to: an acrylate monomer, acrylate polymer, and mixtures thereof. The acrylate can be provided in various forms. For example, the acrylate can be provided as a solution of acrylate and a solvent.

The one or more catalysts can include, but is not limited to: a first catalyst, a second catalyst, a third catalyst, and more catalysts. The one or more catalysts can include, but is not limited to: a Ziegler-Natta catalyst, vanadium oxytrichloride (VOCl₃), metallocene bis(indenyl) zirconium dichloride, ethylene bis(indenyl) zirconium dichloride (Eurecene 5036), and methylphenylbis(cyclopentadienyl) zirconium dichloride, other metallocenes, and mixtures thereof. The catalyst can be provided in various forms. For example, the catalyst can be provided as a solution of the catalyst and a solvent.

The one or more cocatalysts can include, but is not limited to: a first cocatalyst, a second cocatalyst, a third cocatalyst, and more cocatalysts. The one or more cocatalysts can include, but is not limited to: triisobutyl aluminum (TIBA); N,N-dimethylanilinium tetrakis(pentafluorophenyl) borate; ethyl aluminum sesqui chloride; methylaluminoxane (MAO); and mixtures thereof. The cocatalyst can be provided in various forms. For example, the cocatalyst can be provided as a solution of cocatalyst and a solvent with a flow rate to a reactor.

The one or more catalyst reactivators can include, but is not limited to: a first catalyst reactivator, a second catalyst reactivator, a third catalyst reactivator, and more catalyst reactivators. The one or more catalyst reactivators can include, but is not limited to: monochlorophenylacetic acid ethyl ester (MCPAE), dichlorophenylacetic acid ethyl ester (DCPAE), and mixtures thereof. The catalyst can be provided in various forms. For example, the catalyst reactivators can be provided as a solution of the catalyst reactivators and a solvent with a flow rate to a reactor.

The one or more additives can include, but is not limited to: one or more catalysts, one or more cocatalysts, one or more catalyst reactivators, one or more curing agents, one or more crosslinking compounds, one or more oils, one or more paraffinic oils, one or more acids, one or more bases, one or more buffers, one or more wetting agents, one or more surfactants, one or more pigments, one or more opacifying agents, one or more anti-foam agents, one or more antioxidants, one or more stabilizers, one or more tackifier agents, one or more pigments, one or more fillers, one or more dispersants, water, and mixtures thereof. The additive can be provided in various forms. For example, the additive can be provided as a solution of the additive and a solvent with a flow rate to a reactor.

The one or more curing agents can include, but is not limited to: one or more peroxides, one or more amines, one or more sulfur compounds, one or more organosiloxanes, 2,2′-(4-methylphenylimino)diethanol, and mixtures thereof. In some embodiments, the substituted styrene polymer can be cured with ultraviolet (UV) light. The one or more crosslinking compounds, but is not limited to: one or more peroxide compounds, one or more sulfur compounds, one or more platinum catalysts, ultraviolet light, and mixtures thereof.

The substituted styrene polymer can have a content of the one or more additives that can vary widely. For example, the substituted styrene polymer can have a content of the one or more additives from a low of about 0.1 wt %, about 0.5 wt %, or about 1 wt %, to a high of about 50 wt %, about 70 wt %, or about 90 wt %. In another example, the substituted styrene polymer can have content of the one or more additives from about 0.1 wt % to about 90 wt %, 0 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 19 wt % to about 27 wt %, about 15 wt % to about 27 wt %, about 14 wt % to about 24 wt %, about 11 wt % to about 28 wt %, about 33 wt % to about 48 wt %, about 51 wt % to about 54 wt %, or about 50 wt % to about 60 wt %. The weight percent of the based on the total weight of the substituted styrene polymer, or based on the total weight of the one or more substituted styrenes, one or more acrylates, one or more carrier fluids, and one or more additives.

The substituted styrene polymer can have a water content that varies widely. For example, the substituted styrene polymer can have a water content from a low of about 0 wt %, about 0.5 wt %, or about 1 wt %, to a high of about 50 wt %, about 70 wt %, or about 90 wt %. In another example, the substituted styrene polymer can have a water content of less than 5 wt %, less than 2 wt %, or less than 1 wt %. In another example, the substituted styrene polymer can have a water content from about 0 wt % to about 90 wt %, 0.1 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 30 wt % to about 54 wt %, about 33 wt % to about 48 wt %, about 51 wt % to about 54 wt %, or about 50 wt % to about 60 wt %. In another example, the substituted styrene polymer can be free of water. The weight percent of the water in the substituted styrene polymer can be based on the total weight of the substituted styrene polymer, or based on the total weight of the one or more substituted styrenes, one or more acrylates, one or more carrier fluids, and one or more additives.

In some embodiments, the method of making substituted styrene polymers can include a one-pot synthesis or a multi-batch synthesis. For example, the method of making substituted styrene polymers can include a first reactor, second reactor, third reactor, fourth reactor, and more reactors. In another example, method of making substituted styrene polymers can include reactors in a series or reactors in parallel.

In some embodiments, the method of making substituted styrene polymers can include, but is not limited: adding carrier fluid to a reactor, heating the reactor and its contents; purging with the reactor with an inert gas; adding surfactant to the reactor, such as Polystep A16; adding a first catalyst to the reactor; adding styrene or substituted styrene monomers to the reactor; one or more acrylic monomers to the reactor; cooling the reactor and its contents; adding a second catalyst or clean-up catalyst to the reactor; adding a clean-up activator to the reactor; and clean-up activator over 30 minutes; adding a biocide, such as Nuosept 515RX, to the reactor; filtering product; and combinations thereof.

The first reaction mixture, second reaction mixture, and/or catalyst mixture can be reacted and/or stirred in an open container or a closed container. The first reaction mixture, second reaction mixture, and catalyst mixture can be reacted and/or stirred under a vacuum. The first reaction mixture, second reaction mixture, and/or catalyst mixture can be reacted and/or stirred under an inert atmosphere, such as He, Ne, N₂, and Ar.

In some embodiments, the first reaction mixture, second reaction mixture, and/or catalyst mixture can be reacted and/or stirred under a widely varying gauge pressure. For example, the first reaction mixture, second reaction mixture, and catalyst mixture can be reacted and/or stirred under a gauge pressure from a low of about 0.1 psig, about 1 psig, or about 5 psig, to a high of about 50 psig, about 90 psig, or about 300 psig. In another example, first reaction mixture and second reaction mixture can be reacted and/or stirred under a gauge pressure from about 30 psig to about 85 psig, about 0.1 psig to about 90 psig, about 0.1 psig to about 1 psig, about 1 psig to about 85 psig, about 20 psig to about 90 psig, about 5 psig to about 20 psig, about 25 psig to about 75 psig, about 50 psig to about 175 psig, about 55 psig to about 235 psig, or about 0.1 psig to about 300 psig.

The first reaction mixture, second reaction mixture, and/or catalyst mixture can be agitated and/or stirred. For example, first reaction mixture, second reaction mixture, and catalyst mixture can be stirred from about 50 revolution per minute (rpm) to about 1,500 rpm, about 50 rpm to about 500 rpm, or about 60 rpm to about 1,000 rpm.

The first reaction mixture, second reaction mixture, and/or catalyst mixture can have a viscosity that can vary widely. For example, the first reaction mixture, second reaction mixture, and/or catalyst mixture can have a viscosity from a low of about 100 cP, about 1,000 cP, or about 100,000 cP, to a high of about 250,000 cP, about 900,000 cP, or about 2,500,000 cP. In another example, the first reaction mixture and second reaction mixture can have a viscosity from about 100 cP to about 2,500,000 cP, about 1,000 cP to about 250,000 cP, about 2,500 cP to about 250,000 cP, about 2,500 cP to about 2,500,000 cP, about 10,000 cP to about 100,000 cP, about 10,000 cP to about 50,000 cP, about 100,000 cP to about 250,000 cP, about 620,000 cP to about 850,000 cP, about 700,000 cP to about 750,000 cP, about 700,000 cP to about 800,000 cP, about 650,000 cP to about 855,000 cP, about 700,000 cP to about 800,000 cP, about 500,000 cP to about 1,000,000 cP, or about 500,000 cP to about 2,500,000 cP. The viscosity of the first reaction mixture, second reaction mixture, and/or catalyst mixture can be measured on a Brookfield viscosimeter. The viscosity of the first reaction mixture, second reaction mixture, and/or catalyst mixture can be measured at various temperatures, such as 25° C., 40° C., 60° C., and 100° C.

The pH of the first reaction mixture, second reaction mixture, and/or catalyst mixture can vary widely. For example, first reaction mixture and second reaction mixture can have a pH from about 4.0 to about 12.0, about 5.0 to about 10.0, about 7.5 to about 11.0, about 7.0 to about 10.0, about 8.0 to about 9.0, about 9.0 to about 10.0, about 8.0 to about 10.0, about 9.0 to about 11.0, or about 6.0 to about 9.0.

The first reaction mixture, second reaction mixture, and/or catalyst mixture can be heated to a temperature from a low of about 0° C., about 15° C., and about 25° C., to a high of about 35° C., about 65° C., and about 200° C. For example, the first reaction mixture, second reaction mixture, and/or catalyst mixture can be heated to a temperature from about 25° C. to about 28° C., about 25° C. to about 35° C., about 25° C. to about 90° C., about 30° C. to about 45° C., about 40° C. to about 90° C., about 43° C. to about 78° C., about 40° C. to about 90° C., about 100° C. to about 200° C. In another example, the first reaction mixture, second reaction mixture, and/or catalyst mixture can be at room temperature. In another example, the reaction occurs at a temperature of greater than about 40° C. or greater than about 50° C. The first reaction mixture, second reaction mixture, and/or catalyst mixture can be performed at different temperatures.

The first reaction mixture can be reacted and/or stirred for a first reaction time from a short of about 15 s, about 120 s, or about 300 s, to a long of about 1 h, about 24 h, or about 72 h. For example, the first reaction time can be from about 1 min to about 15 min, about 5 min to about 45 min, about 1 h to about 7 h, about 1 h to about 12 h, about 5 h to about 15 h, about 10 h to about 24 h, about 12 h to about 17 h, about 12 h to about 24 h, about 22 h to about 50 h, or about 24 h to about 72 h.

The second reaction mixture can be reacted and/or stirred for a second reaction time from a short of about 15 s, about 120 s, or about 300 s, to a long of about 1 h, about 24 h, or about 72 h. For example, the second reaction time can be from about 1 min to about 15 min, about 5 min to about 45 min, about 1 h to about 7 h, about 5 h to about 15 h, about 10 h to about 24 h, about 12 h to about 17 h, about 12 h to about 24 h, about 22 h to about 50 h, or about 24 h to about 72 h.

The catalyst mixture can be reacted and/or stirred for a second reaction time from a short of about 15 s, about 120 s, or about 300 s, to a long of about 1 h, about 24 h, or about 72 h. For example, the catalyst mixture time can be from about 1 min to about 15 min, about 5 min to about 45 min, about 1 h to about 7 h, about 1 h to about 12 h, about 5 h to about 15 h, about 10 h to about 24 h, about 12 h to about 17 h, about 12 h to about 24 h, about 22 h to about 50 h, or about 24 h to about 72 h.

In one or more embodiments, the substituted styrene polymer can be mixture of one or more substituted styrene polymers. For example, the substituted styrene polymer can be mixture of two substituted styrene polymers, three substituted styrene polymers, four substituted styrene polymers, or more substituted styrene polymers. In another example, the substituted styrene polymer can a mixture of a low molecular weight substituted styrene polymers and a high molecular weight substituted styrene polymer. In another example, the substituted styrene polymer can be a mixture of a first substituted styrene polymer and a second substituted styrene polymer in a weight ratio that varies widely. For example, the substituted styrene polymer can have two substituted styrene polymers in a weight ratio of about 10:90, about 20:80, about 30:70, about 40:60, about 45:55, about 50:50, about 55:45, about 60:40, about 70:30, about 80:20, or about 90:10.

In one or more embodiments, the substituted styrene polymers can be used in a wide variety of commercial products. For example, the substituted styrene polymers can be used in coatings, roof coatings, adhesives, liquid injection molding (LIM), additive manufacturing (3D Printing), binders for heat conducting/dissipating electronic materials, lubes, gear oils, greases, caulks, oil additives, high hardness compounds, reactive plasticizers, and polymer modification applications.

The substituted styrene polymer emulsion can have a viscosity that varies widely. For example, the substituted styrene polymer emulsions can have a viscosity from a low of about 1 cP, about 1,000 cP, or about 100,000 cP, to a high of about 250,000 cP, about 900,000 cP, or about 2,500,000 cP. In another example, the substituted styrene polymer emulsion can have a viscosity from about 1 cP to about 2,500,000 cP, about 100 cP to about 2,000,000 cP, about 100 cP to about 10,000 cP, about 10,000 cP to about 100,000 cP, about 1,000 cP to about 250,000 cP, about 10,000 cP to about 50,000 cP, about 100,000 cP to about 250,000 cP, about 620,000 cP to about 850,000 cP, about 700,000 cP to about 750,000 cP, about 700,000 cP to about 800,000 cP, about 650,000 cP to about 855,000 cP, about 700,000 cP to about 800,000 cP, about 500,000 cP to about 1,000,000 cP, or about 500,000 cP to about 2,500,000 cP. The viscosity of the substituted styrene polymer emulsion can be measured on a Brookfield viscosimeter. The viscosity of the substituted styrene polymer emulsion can be measured at various temperatures, such as 25° C., 40° C., 60° C., and 100° C.

The substituted styrene polymer emulsion can have a solids content that varies widely. For example, the substituted styrene polymer emulsion can have a solids content from a low of about 1 wt %, about 10 wt %, or about 30 wt %, to a high of about 70 wt %, about 80 wt %, or about 95 wt %. In another example, the substituted styrene polymer emulsion can have a solids content greater than about 50 wt %, about 55 wt %, or about 70 wt %. In another example, the substituted styrene polymer emulsion can have a solids content from about 1 wt % to about 95 wt %, about 5 wt % to about 12 wt %, about 7 wt % to about 20 wt %, about 45 wt % to about 55 wt %, about 47 wt % to about 54 wt %, about 30 wt % to about 54 wt %, about 33 wt % to about 48 wt %, about 51 wt % to about 54 wt %, or about 50 wt % to about 60 wt %. The weight percent of the solids content of substituted styrene polymer can be based on the total weight of the substituted styrene polymer; or based on the total weight of the one or more substituted styrenes, one or more acrylates, one or more carrier fluids, and one or more additives.

The coating composition can be used in a wide variety of products. For example, the coating composition can be a primer composition, paint, concrete sealer, and combinations thereof. In one or more embodiments, the coating composition can include, but is not limited to: a colloid, dispersion, latex, emulsion, gel, foam, sol, aerosol, and combinations thereof.

### EXAMPLES

To provide a better understanding of the foregoing discussion, the following non-limiting examples are offered. Although the examples can be directed to specific embodiments, they are not to be viewed as limiting the invention in any specific respect.

Examples of the coating compositions were made. The method of making the coating compositions is shown in Table 3.

TABLE 3
Method of Making the Coating Compositions

1. Add DI water to the reactor.
2. Heat reactor to 180-183° F. (82-84° C.).
3. Purge with nitrogen for 20 minutes.
4. After purge, add Polystep A16.
5. Prepare initial catalyst and delayed catalyst feed.
6. At 183° F., add 5% of PE to reactor
7. Immediately add initial catalyst
8. At peak exotherm, start PE and catalyst feeds over
PE feed rate 814 3.39 mL/min
Catalyst feed rate 47.6 0.20 mL/min
9. Maintain temperature 180° F.-183° F. (82-84° C.)
10. After feeds complete, hold for 30 minutes at 180° F.-183° F.
(82-84° C.)
11. Cool to 140° F. (40° C.)
12. At 140 feed clean-up catalyst and clean-up activator over 30 minutes.
clean-up catalyst: 11.6 30 0.39 g/min
clean-up activator: 11.3 30 0.38 g/min
13. Hold for 15 minutes
14. Add Nuosept 515RX or equivalent
15. Rinse biocide to reactor with DI water
16. Adjust NV if necessary
17. Filter product through 150 mesh

Performance comparisons of substituted styrene polymer emulsions, using vinyltoluene, p-methyl styrene, and 4-t-butyl styrene, with styrene-acrylic and all-acrylic polymer emulsions in direct-to-metal and wood coatings were performed. The results demonstrate improved hardness and hardness development, water resistance (whitening, blushing), and UV resistance differences.

The monomer composition in each series was adjusted to similar T_{g} with different monomers. Glass transition temperature was in the expected range, with VT giving lower than expected value (the deviation between PMS and VT is attributed to isomer distribution in VT). Two sets of latexes were synthesized and evaluated in wood primer application: WP1 and WP2. The results are shown in Table 4. Clear coatings were evaluated for UV and moisture resistance. TBS-based emulsions in wood primer applications have demonstrated improved performance consistent with the better moisture resistance and hardness.

TABLE 4
Properties of Coating Compositions

| | | | | |
|---|---|---|---|---|
| Monomer | ST | VT | PMS | TBS |

WP1 (target T_{g} = 28° C.)

| | | | | |
|---|---|---|---|---|
| T_{g}, ° C. | 27 | 28 | 28 | 20 |
| viscosity, cPs | 560 | 1140 | 1590 | 3740 |
| particle size, nm | 88.8 | 87.7 | 91.3 | 74.3 |

WP2 (target T_{g} = 55° C.)

| | | | | |
|---|---|---|---|---|
| T_{g} (inflection) | 54 | 54 | 59 | 54 |
| viscosity, cPs | 54 | 420 | 58 | 160 |
| particle size, Dv | 99.4 | 101.6 | 96.6 | 75.3 |
| König hardness, sec ⁽¹⁾ | 141 | 137 | 149 | 192 |

⁽¹⁾ clear coating on glass, 30% Dowanol DPnB cosolvent, drawdown bar applicator, 3 mil wet

The glass transition temperature (T_{g}) of the substituted styrene polymer was determined was determined by ASTM D7426, Standard Test Method for Assignment of the DSC Procedure for Determining glass transition temperature of a Polymer or an Elastomeric Compound (Withdrawn 2022)). The hardness and hardness development was determined by ASTM D4366 Hardness of Organic Coatings by Pendulum Damping Tests (Method A). The moisture resistance and hydrophobicity of the substituted styrene polymer was determined by a Water Soak (ASTM D471, Standard Test Method for Rubber Property—Effect of Liquids, or ASTM D 570, Standard Test Method for Water Absorption of Plastics) contact angle (visual observation) water spot test (visual observation) blush test [23]. The UV resistance of the substituted styrene polymer was determined by ASTM G154, Standard Practice for Operating Fluorescent Ultraviolet (UV) Lamp Apparatus for Exposure of Nonmetallic Materials). The minimum film forming temperature of the substituted styrene polymer was determined by ASTM D2354, Standard Test Method for Minimum Film Formation Temperature (MFFT) of Emulsion Vehicles. The compositional analysis of the substituted styrene polymer was determined by ASTM E1131, Standard Test Method for Compositional Analysis by Thermogravimetry). The chemical resistance of the substituted styrene polymer was determined by ASTM D1308, Standard Test Method for Effect of Household Chemicals on Clear and Pigmented Coating Systems. The Latex viscosity of the substituted styrene polymer was determined by a Brookfield LV viscometer, spindle #4 @20 rpm.

### Hardness and Hardness Development

Glass transition temperature is an intrinsic property of a polymer that defines important performance characteristics like film formation properties and hardness. Depending on copolymer composition, the properties can be further improved even at the same Tg. Clear coating—30% Dowanol DPnB cosolvent, drawdown bar applicator, 3 mil wet on glass panel. White gloss DTM paint formula—drawdown bar applicator, 3 mil wet on steel panel

Copolymer emulsions with PMS and TBS produced films with higher hardness. In the case of TBS, hardness at similar Tg can be related to a different copolymer and particle morphology. The Tg difference between PMS and VT could be attributed to isomer distribution in VT, and, possibly, to the copolymer and particles morphology. White gloss DTM2 paint formula, coating hardness is measured on 5 mil dry film thickness on steel panel. Hardness with TBS was notably higher. MFFT with TBS was higher compared to the observed Tg, which may require some adjustments for coalescing aid in paint formulations. One of the important properties of paints is drying time—this was evaluated by hardness development test.

Clear coating with Butyl Cellosolve @25%, as coalescing aid, drawdown 3 mil wet on glass. PMS and, especially TBS provided notably better performance—much higher hardness and faster hardness development at similar Tg's. VT produced softer coating and hardness development was slower than ST. The absence of correlation with Tg is most likely related to differences in film forming properties due to copolymer composition and specific particle morphology resulting from monomer reactivity differences and deserves more thorough examination.

UV Resistance—Differences in Yellowing of Polymers Made with Substituted Styrene Monomers

UV resistance of the polymers in clear and formulated white coatings were evaluated using QUV method by measuring b* value of clear and white gloss coating formulation (blue-yellow coordinate in CIELAB color space) after exposure to UV. White gloss DTM paint formula, 3 mil wet drawdowns on standard Leneta cards (DTM1 series). White gloss paint formula, 3 mil wet drawdown on standard Leneta card. WP clear coatings were evaluated for UV resistance using QUV in comparison to two competitive all-acrylic products (>500 hrs). Neat emulsions with 30% (w/w polymer) cosolvent DPnB, drawdowns 3 mil wet on standard Leneta cards. From left to right: ST, VT, PMS, TBS, TBS (2), Acrylic 1, Acrylic 2. Neat emulsions with 30% (w/w polymer) cosolvent DPnB, drawdowns 3 mil wet on standard Leneta cards.

TBS based polymer demonstrated UV resistance comparable to all-acrylic polymers, known for good UV resistance. VT and PMS-containing polymers showed more pronounced yellowing in both, white gloss DTM1 formula and WP clear coatings. TBS showed excellent resistance to UV light—in photooxidation reactions, stabilization effect by steric hindrance of the bulky t-butyl group overcomes the effect of electron density donation. TBS copolymer demonstrated robust resistance to UV exposure comparable to all-acrylic polymers. VT and PMS discolored more than ST because of electron density donation by alkyl substituents on the aromatic ring.

### FR/Intumescent Coating

U.S. Pat. No. 7,417,091 [22] specifically claims benefits of using PMS and TBS in polymer binder for intumescent coatings in combination with crosslinking (reticulated polymer). Two CS emulsions containing TBS were evaluated in intumescent coating application by Bunsen burner test. Aluminum 4×6″ panels were coated at 15 mil wet thickness, dried at RT/7 days and tested as follows: the panels were placed at 45° angle, exposed to 0.5″ Bunsen burner flame for 5 minutes. Flame spread and char formation is evaluated visually.

The combination of TBS and crosslinking drastically increases expansion of the coating upon exposure to open flames and is expected to improve thermal insulation properties. It is comparable to the commercial emulsion.

The substituted styrene monomers, VT, PMS, and TBS, were evaluated in combination with different acrylic comonomers for properties adjustment, suitable for DTM, wood coating applications, concrete sealer, and intumescent coatings. Copolymer emulsions with PMS and, especially, TBS-containing copolymers with similar glass transition temperatures (T_{g}) produced superior hardness and hardness development—demonstrated by tests on clear DTM and WP coatings and pigmented paint formulations. TBS-containing copolymer emulsions demonstrated exceptional UV resistance, on par with all-acrylic products, Emulsions based on TBS exhibited exceptional water resistance, as shown by water spot, soak and blushing tests, outperforming all-acrylic self-crosslinking and VeoVa monomer-based polymer emulsions. VT higher boiling point (compared to ST) makes it more acceptable as a reactive diluent from EHS standpoint. PMS has potential in high-end applications. Two TBS-based emulsions, WP-TBS and WP2-TBS have been evaluated in wood primer application and results of evaluation demonstrated exceptional sandability and good waterborne topcoat hold-out after recoating. WP2 was slightly better for the recoat.

One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should also be appreciated that the numerical limits may be the values from the examples. Certain lower limits, upper limits and ranges appear in at least one claims below. All numerical values are “about” or “approximately” the indicated value, and consider experimental error and variations that would be expected by a person having ordinary skill in the art.

### REFERENCES

1. Arriaga, V., Vanaken, D. Branched Vinyl Ester Monomers for Hydrophobic Emulsion Polymers. PCI Mag (2013).
2. Yaws C L et. Al.; Chem. Eng., 97: 177-81 (1990) https://pubchem.ncbi.nlm.nih.gov/compound/3-Methylstyrene#section=Other-Identifiers.
3. Alexander S. Dunn, Latex particle nucleation in emulsion polymerization, Eur. Polym. J., 25, 7-8, 1989, 691-694. cited: Dow Chemical Co. Technical Bulletin on tert-butyl styrene monomer.
4. Canterino, P. J., Chemically cross-linked poly(p-methylstyrene), U.S. Pat. No. 4,230,836, 1980 (DSC, onset).
5. https://www.sigmaaldrich.com/US/en/technical-documents/technical-article/materials-science-and-engineering/polymer-synthesis/thermal-transitions-of-homopolymers.
6. Robertson, B. A. Low-HAP and Zero-HAP Polyester Resin Systems And Articles Prepared Using Same. U.S. Pat. No. 7,723,431, 2010.
7. Bardman, J. K. Aqueous Dispersion Of Multistage Polymer Particles. U.S. Pat. No. 11,186,741, 2021.
8. Zhang, L, et. al., Water resistant polymers for personal care. U.S. Pat. No. 9,820,929, 2017.
9. Brennan, D. J., et. al. Compositions Comprising Polyether—Urethane—Urea Additives For Block Resistance And Open Time. U.S. Pat. No. 10,654,964, 2020.
10. Karikari A. S., et al., Epoxy-Fortified Floor Polishes. U.S. Pat. No. 9,969,904, 2018.
11. Guenther, G., et. al. Ink-jet printing ink. U.S. Pat. No. 9,447,295, 2016.
12. Willis, C. L., et. al. Sulfonated block copolymers, method for making same, and various uses for such block copolymers. U.S. Pat. No. 7,737,224. 2010.
13. Kim, J. H., et. al. Homogeneous cation-exchange composite membrane U.S. Pat. No. 10,543,463. 2020.
14. Fujino, Y. Optical film and polarizing plate. U.S. Pat. No. 10,941,236, 2021.
15. Kim, D. H. Method of forming topcoat for patterning U.S. Pat. No. 10,755,942, 2020.
16. Sulfonation and Characterization of Tert-Butyl Styrene/Styrene/Isoprene Copolymer and Polypropylene Blends for Blood Compatibility Applications by Bin-Hong Tsai, Yung-Han Chuang, Chi-Hui Cheng, Jui-Che Lin, Polymers 2020, 12(6), 1351.
17. Preparation of porous poly(4-tert-butylstyrene) based monoliths with high efficiency for oil-water separation via high internal phase emulsion template, Zhao, Y., Shen, L., Yuan, Y., Xiao, L., Cai, J., Lu, Z., Hou, L., J. Appl. Polym. Sci. 2023, 140(18), e53801.
18. Synthesis of Multifunctionalized Graft-Type Polyolefin-Based [polyolefin-graft-poly(t-butylstyrene)] Elastomers with a High Utility Temperature, Macromol. Chem. Phys. 2017, 218, 1700298.
19. Application of block polymers to patterning thin films for use in the manufacturing of semiconductor devices and computer memory: e.g. Photopatterning of Block Copolymer Thin Films. ACS Macro Lett. 2016, 5, 460-465.
20. Hurlbut, C. R. and Kusner, M. R., Organic scintillators for modern calorimetry, 2nd International Conference on Calorimetry in High-energy Physics, 1991, 179-183.
21. Liu Zhenting. Vinyltoluene/acrylamide-based high-elasticity storage battery sealant and manufacturing method thereof, CN Application No: 201610486517, 2016.
22. Magnet, S., et. Al., Polymer Binder for Intumescent Coatings U.S. Pat. No. 7,417,091. 2008.
23. Bassett, D. R. (2001). Hydrophobic coatings from emulsion polymers. Journal of Coatings Technology, 73(1), 43-55. doi:10.1007/bf02698496.
24. https://www.mica-tron.com/syntactic-foams/.

What is claimed is:

1. A coating composition comprising:
one or more polymers, wherein the one or more polymers comprise: one or more substituted styrenes and one or more acrylates, wherein the one or more substituted styrenes is selected from meta-vinyltoluene, para-vinyltoluene, meta-methylstyrene, para-methylstyrene, para-tertiary butylstyrene, and mixtures thereof, and wherein the one or more acrylates is selected from 2-ethylhexyl acrylate, acrylic acid, one or more (methyl)acrylates, one or more (ethyl)acrylates, butylacrylate, and mixtures thereof;
one or more carrier fluids; and
one or more additives.

2. The coating composition of claim 1, wherein the one or more polymers has a content of the one or more substituted styrenes from about 10 wt % to about 20 wt %, wherein the one or more acrylates is 2-ethylhexyl acrylate and methacrylic acid, wherein the one or more polymers has a content of 2-ethylhexyl acrylate from about 10 wt % to about 20 wt %, and about 10 wt % to about 20 wt % of methacrylic acid, and wherein the one or more polymers has a content of methacrylic acid acrylate from about 10 wt % to about 20 wt %.

3. The coating composition of claim 1, wherein the one or more polymers has a content of the one or more substituted styrenes from about 1.0 wt % to about 60.0 wt %, and wherein the one or more polymers has a content of the one or more acrylates from about 1.0 wt % to about 60.0 wt %.

4. The coating composition of claim 1, wherein the one or more polymers further comprises styrene, and wherein the one or more polymers has a content of the styrene from about 1.0 wt % to about 50.0 wt %.

5. The coating composition of claim 1, wherein the one or more additives is selected from one or more pigments, one or more fillers, one or more dispersants, one or more wetting agents.

6. The coating composition of claim 1, wherein the coating composition has a viscosity from about 100 cP to about 10,000 cP at 25° C.

7. The coating composition of claim 1, wherein the coating composition has a König hardness from about 15 to about 200.

8. The coating composition of claim 1, wherein the coating composition is an emulsion or a latex.

9. The coating composition of claim 8, wherein the one or more polymers has an average cross-sectional length from about 1.0 nm to about 5.0 mm.

10. The coating composition of claim 8, wherein the one or more polymers has a molecular weight from about 2,500 g/mol to about 10,000,000 g/mol.

11. The coating composition of claim 8, wherein the one or more polymers have a glass transition temperature from about 10° C. to about 90° C.

12. A method for making a coating composition, the method comprising:
contacting a one or more surfactants, a chain transfer agent, one or more styrene monomers, one or more acrylic monomers, a first carrier fluid, and a first catalyst to produce a prepolymer, wherein the one or more styrene monomers is selected from styrene, meta-vinyltoluene, para-vinyltoluene, meta-methylstyrene, para-methylstyrene, para-tertiary butylstyrene, and mixtures thereof, and wherein the one or more acrylic monomers is selected from 2 ethylhexyl acrylate acrylic acid, one or more acrylates, one or more (methyl)acrylates, one or more (ethyl)acrylates, 2-ethylhexylacrylate, butylacrylate, and mixtures thereof,
combining the prepolymer with a second carrier fluid, and a second catalyst to produce a second reaction mixture;
polymerizing the prepolymer to make one or more polymers; and
adding one or more additives to the one or more polymers to make the coating composition.

13. The method of making a coating composition of claim 12, wherein the one or more polymers has a content of the one or more substituted styrenes from about 10 wt % to about 20 wt %, wherein the one or more acrylates is 2-ethylhexyl acrylate and methacrylic acid, wherein the one or more polymers has a content of 2-ethylhexyl acrylate from about 10 wt % to about 20 wt %, and about 10 wt % to about 20 wt % of methacrylic acid, and wherein the one or more polymers has a content of methacrylic acid acrylate from about 10 wt % to about 20 wt %.

14. The method of making a coating composition of claim 12, wherein the one or more polymers has a content of the one or more substituted styrenes from about 1.0 wt % to about 60.0 wt %, and wherein the one or more polymers has a content of the one or more acrylates from about 1.0 wt % to about 60.0 wt %.

15. The method of making a coating composition of claim 12, wherein the coating composition has a viscosity from about 100 cP to about 10,000 cP at 25° C.

16. The method of making a coating composition of claim 12, wherein the coating composition has a König hardness from about 15 to about 200.

17. The method of making a coating composition of claim 12, wherein the coating composition is an emulsion or a latex.

18. The method of making a coating composition of claim 12, wherein the one or more polymers has an average cross-sectional length from about 1.0 nm to about 5.0 mm.

19. The method of making a coating composition of claim 12, wherein the one or more polymers has a molecular weight from about 2,500 g/mol to about 10,000,000 g/mol.

20. The method of making a coating composition of claim 12, wherein the one or more polymers have a glass transition temperature from about 10° C. to about 134° C.
